(19) United States
(12) Patent Application Publication
(10) Pub. No.: US 2015/0379542 A1
(43) Pub. Date: Dec. 31, 2015

(54) TRANSACTIVE CONTROL FRAMEWORK FOR HETEROGENEOUS DEVICES

(71) Applicant: Battelle Memorial Institute, Richland, WA (US)

(72) Inventors: Jianming Lian, Richland, WA (US); Karanjit Kalsi, Richland, WA (US); Jason C. Fuller, Richland, WA (US); Krishnappa Subbarao, Vienna, VA (US)

(73) Assignee: BATTELLE MEMORIAL INSTITUTE, Richland, WA (US)

(21) Appl. No.: 14/788,473

(22) Filed: Jun. 30, 2015

Related U.S. Application Data
(60) Provisional application No. 62/019,242, filed on Jun. 30, 2014.

(51) Int. Cl. G06Q 30/02; G06Q 50/06

(52) U.S. Cl. CPC G06Q 30/0206; G06Q 50/06

(57) ABSTRACT

Various innovations for a transactive control framework with heterogeneous devices such as refrigerators, air conditioners, water heaters, and clothes dryers, or components of such systems/units, are presented. For example, an aggregator for the transactive control framework receives bids from device controllers for heterogeneous devices. Different bids can reflect different behaviors of heterogeneous devices under one transactive control framework, which allows the heterogeneous devices to participate in the same ancillary service market for power. The aggregator determines a cleared price value, then broadcasts the cleared price value and a regulation signal to the device controllers. The device controllers can use a stochastic decision-making process to regulate power utilization by the respective heterogeneous devices, such that the aggregate behavior of the controlled devices tracks the regulation signal. In many case, the transactive control framework helps the devices, collectively, provide a regulation service according to the regulation signal.

### CROSS REFERENCE TO RELATED APPLICATION

The present application claims the benefit of U.S. Provisional Patent Application No. 62/019,242, filed Jun. 30, 2014, the disclosure of which is hereby incorporated by reference.

### ACKNOWLEDGMENT OF GOVERNMENT SUPPORT

This invention was made with government support under Contract DE-ACO5-76RL01830 awarded by the U.S. Department of Energy. The government has certain rights in the invention.

### BACKGROUND

In the context of a power generation grid, ancillary services provide supplementary power on a short-term, on-demand basis. In some cases, ancillary services are supplied by power plants that are not producing power at their most efficient output level, which can tie up expensive capital investment, waste fuel, and increase wear and tear from continually adjusting power plant output in response to the immediate balancing needs of the grid. Further, the need for ancillary services is projected to increase substantially as renewable power generation reaches 20% of power plant capacity and beyond, since the power provided by renewable generation can be unpredictable (e.g., depending on wind or weather).

Rather than rely on adjustments of the output of a centralized power plant, distributed energy resources (“DERs”) such as distributed generation, storage and responsive loads can provide equivalent services by adjusting their power output and/or their power demand. Recently, various projects have provided ways to harness the power of DERs so as to adjust to power output and/or power demand. Such projects are limited, however, in terms of their scalability and their flexibility to work with different types of devices.

### SUMMARY

In summary, the detailed description presents various innovations for a transactive control framework with heterogeneous devices such as refrigerators, air conditioners, water heaters, and clothes dryers, or individual controllable components of such systems/units (such as a compressor of a refrigerator). For example, an aggregator for the transactive control framework receives bids from device controllers for heterogeneous devices. Different bids can reflect different behaviors of heterogeneous devices under one transactive control framework, which allows the heterogeneous devices to participate in the same ancillary service market for a resource. The aggregator determines a cleared price value, then broadcasts the cleared price value and a regulation signal to the device controllers. The device controllers can use a stochastic decision-making process to regulate utilization of the resource by the respective heterogeneous devices, such that the aggregate behavior of the devices tracks the regulation signal. In many case, the transactive control framework helps the devices, collectively, provide a regulation service according to the regulation signal.

According to a first set of innovations described herein, an aggregator for a transactive control framework receives multiple bids for a period of an ancillary service market (“market period”) for a resource. The bids are from device controllers for a set of heterogeneous devices. The aggregator determines (e.g., itself sets, or receives from an external module) a cleared price value for the market period. The cleared price value is based at least in part on a market signal and the multiple bids. The aggregator broadcasts the cleared price value for the market period to the device controllers. The aggregator also receives a regulation signal and broadcasts the regulation signal to the device controllers.

A given device controller for a device in a transactive control framework performs corresponding operations. The device is part of a set of heterogeneous devices under the transactive control framework. The device controller determines a bid by the device for a period of an ancillary service market for a resource. The device controller sends the bid to an aggregator for the transactive control framework. The device controller receives a cleared price value for the market period, then decides whether or not the device will participate in the ancillary service market during the market period. When the device participates in the ancillary service market during the market period, the device controller also receive a regulation signal and, based at least in part on the regulation signal, regulates utilization of the resource by the device during the market period.

According to a second set of innovations described herein, a device controller for a device in a transactive control framework uses a stochastic decision-making process when regulating utilization of a resource by the device. The device controller receives a regulation signal and, based at least in part on the regulation signal, regulates utilization of the resource by the device during a period of an energy market. In regulating utilization of the resource by the device, the device controller uses a stochastic decision-making process. As part of the stochastic decision-making process, based at least in part on the regulation signal, the device controller determines a target power modulation. Based at least in part on the target power modulation, the device controller determines a transition probability value for transitioning between two discrete operating states of the device. Then, based at least in part on a random number and the transition probability value, the device controller decides whether to transition between the two states of the device. When a large set of device controllers use such a stochastic decision-making process, the aggregate behavior of the controlled devices can closely track the regulation signal.

According to a third set of innovations described herein, a configuration tool for a transactive control framework receives user input and, based at least in part on the user input, generates a profile for a device in an energy market for a resource. The profile incorporates a Markov chain model to characterize discrete operating states of the device and characterize transitions between at least some of the states. The configuration tool configures a device controller to use the profile. In this way, device controllers for heterogeneous devices can be configured so that their devices can participate in the same energy market for a resource.

According to a fourth set of innovations described herein, a device controller for a device in a transactive control framework determines and outputs a bid by the device for a period of an energy market for a resource. The bid has multiple parameters, including a quantity value, a price value, and a quality of service (“QoS”) value. The quantity value indicates an amount of the resource available, at the device, for participation during the period of the energy market. The price value indicates a point at which the device is willing to make the amount of the resource available for participation during the period. Finally, the QoS value indicates how many times the device is able to change between discrete operating states of the device during the period of the energy market. Using such bids, device controllers for heterogeneous devices can participate in the same energy market for a resource.

An aggregator for a transactive control framework performs corresponding operations. The aggregator receives a bid by a device for a period of an energy market for a resource. Based at least in part on the bid and a market signal, the aggregator determines a cleared price value for the period. The bid has multiple parameters, including a quantity value, a price value, and a QoS value, as described in the previous paragraph.

The innovations can be implemented as part of a method, as part of a computing system configured to perform the method or as part of a tangible computer-readable media storing computer-executable instructions for causing a computing system to perform the method. The various innovations can be used in combination or separately. For example, in some implementations, several of the innovations described herein are incorporated in one transactive control framework. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram illustrating an example computing system in which some described embodiments can be implemented.

FIG. 2 is a diagram illustrating an example transactive control framework in which some described embodiments can be implemented.

FIGS. 3 and 4 are flowcharts illustrating generalized techniques for participation in a transactive control framework with a set of heterogeneous devices, from the perspectives of an aggregator and device controller, respectively.

FIGS. 5, 6a, and 6b are diagrams illustrating example approaches to determining the price value of a bid by a device.

FIGS. 7 and 8 are flowcharts illustrating example techniques for using a bid that includes a QoS value, from the perspectives of a device controller and aggregator, respectively.

FIGS. 9a and 9b are diagrams illustrating example approaches to determining a cleared price value in a transactive control framework.

FIGS. 10a and 10b are diagrams illustrating example operating states and state transitions in a device.

FIG. 11 is a flowchart illustrating an example technique for regulating utilization of a resource using a stochastic decision-making process.

FIGS. 12 and 13a-13d are diagrams illustrating example state models for a “smart” refrigerator.

FIG. 14 is a flowchart illustrating an example technique for configuring a device controller in a transactive control framework.

### DETAILED DESCRIPTION

The detailed description presents various aspects of a unified approach to controlling the power output and/or power demand of heterogeneous devices such as refrigerators, air conditioners, water heaters, and clothes dryers, or individual controllable components of such systems/units, under a coordinated, market-based framework. For example, an aggregator for the transactive control framework receives bids from device controllers for heterogeneous devices. Different bids can reflect different behaviors of heterogeneous devices under one transactive control framework, which allows the heterogeneous devices to participate in the same energy market for a resource. The aggregator determines a cleared price value, then broadcasts the cleared price value and regulation signal to the device controllers. The device controllers can use a stochastic decision-making process to regulate utilization of the resource by the respective heterogeneous devices, such that the aggregate behavior of the controlled devices tracks the regulation signal. In many case, the transactive control framework helps the devices, collectively, provide a regulation service according to the regulation signal, and enables large-scale penetration of controllable devices for an ancillary service market.

In the examples described herein, a device can be a refrigerator, air conditioner, water heater, clothes dryer, or other consumer or commercial device, which is controlled as a whole by a device controller. Or, a device can be a component of a refrigerator (e.g., compressor, ice maker, sweat maker, defroster), air conditioner, water heater, clothes dryer, or other consumer or commercial device, where the component is separately controlled by a device controller.

Many of the examples described herein involve a transactive control framework including participants in an ancillary service market (specifically, a power regulation market). Alternatively, many of the approaches described herein can be used in another energy market.

In the examples described herein, identical reference numbers in different figures indicate an identical component, module, or operation. Depending on context, a given component or module may accept a different type of information as input and/or produce a different type of information as output.

More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique/tool does not solve all such problems.

### I. Example Computing Systems.

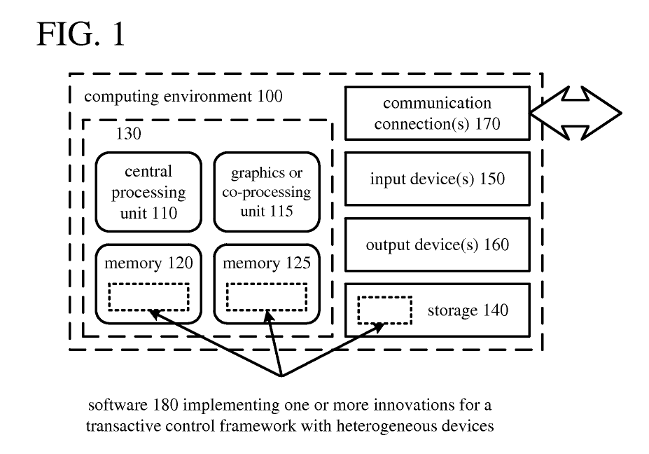

FIG. 1 illustrates a generalized example of a suitable computing system (100) in which several of the described innovations may be implemented. The computing system (100) is not intended to suggest any limitation as to scope of use or functionality, as the innovations may be implemented in diverse general-purpose or special-purpose computing systems.

With reference to FIG. 1, the computing system (100) includes one or more processing units (110, 115) and memory (120, 125). The processing units (110, 115) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 1 shows a central processing unit (110) as well as a graphics processing unit or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for a transactive control framework with heterogeneous devices, in the form of computer-executable instructions suitable for execution by the processing unit(s).

A computing system may have additional features. For example, the computing system (100) includes storage (140), one or more input devices (150), one or more output devices (160), and one or more communication connections (170). An interconnection mechanism (not shown) such as a bus, controller, or network interconnects the components of the computing system (100). Typically, operating system software (not shown) provides an operating environment for other software executing in the computing system (100), and coordinates activities of the components of the computing system (100).

The tangible storage (140) may be removable or non-removable, and includes magnetic disks, magnetic tapes or cassettes, optical media such as CD-ROMs or DVDs, or any other medium which can be used to store information and which can be accessed within the computing system (100). The storage (140) stores instructions for the software (180) implementing one or more innovations for a transactive control framework with heterogeneous devices.

The input device(s) (150) may be a touch input device such as a keyboard, mouse, pen, or trackball, a voice input device, a scanning device, or another device that provides input to the computing system (100). The output device(s) (160) may be a display, printer, speaker, CD-writer, or another device that provides output from the computing system (100).

The communication connection(s) (170) enable communication over a communication medium to another computing entity. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computing system (100), computer-readable media include memory (120, 125), storage (140), and combinations thereof. As used herein, the term computer-readable media does not include transitory signals or propagating carrier waves.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

The disclosed methods can also be implemented using specialized computing hardware configured to perform any of the disclosed methods. For example, the disclosed methods can be implemented by an integrated circuit (e.g., an ASIC such as an ASIC digital signal processor (“DSP”), a graphics processing unit (“GPU”), or a programmable logic device (“PLD”) such as a field programmable gate array (“FPGA”)) specially designed or configured to implement any of the disclosed methods.

For the sake of presentation, the detailed description uses terms like “determine” and “decide” to describe computer operations in a computing system. These terms are high-level abstractions for operations performed by a computer, and should not be confused with acts performed by a human being. The actual computer operations corresponding to these terms vary depending on implementation.

### II. Transactive Control Frameworks—Introduction.

Distributed energy resources (“DERs”) such as power generation devices, power storage devices, and responsive loads (devices that use power to a controlled extent, responsive to a regulation signal) can effectively provide ancillary services by adjusting their power output and/or power demand. Various projects have provided ways to harness the power of DERs to adjust to power output and/or demand.

For example, several direct load control (“DLC”) approaches provide regulation services using thermostatically controlled loads (“TCLs”). The control in such DLC approaches is typically coarse, however, being limited to specific applications (e.g., peak shaving or energy shifting) and/or being limited to a relatively small number of uses per year. Also, in many cases, participation by DERs is limited to industrial plants and large commercial buildings, which limits applicability. (Use of DLC to provide regulation services with smaller devices has been proposed in technical literature, but not yet implemented in practice.) In contrast, various approaches described herein can potentially incorporate a large number of smaller devices to provide regulation services. Previous DLC approaches have several other problems. They require complicated, aggregated modeling to quantify the flexibility of load aggregation, where the aggregated model is typically coarse and only valid under restrictive assumptions. They also assume control of the population of devices, not allowing consumers to determine their own willingness to participate in the regulation service.

As another example, several approaches provide regulation services using price-based mechanisms coupled with automated systems. A price-based mechanism allows consumers to determine their own willingness to participate, potentially in near real-time if they choose to do so. A price-based mechanism rewards participation through incentives or reduced bills. Price-based systems can respect user input for flexibility and comfort, and they have the potential to provide a fine-grained, smooth response when coordinated across a large group of devices. In previous approaches, however, automated systems with price-based mechanisms sometimes fail to achieve a predictable and stable system response.

As another example, a transactive control approach can allow DERs, which are often owned and operated by consumers and third parties, to be integrated with the operations of traditional grid infrastructure. A transactive control approach can produce a smooth, stable, predictable response, as desired by grid operators. Also, as compared to traditional DLC approaches, transactive control solutions emphasize a decentralized approach, where consumer decisions and third-party decisions can be kept local and private. Potentially, transactive control approaches can be used to manage large-scale deployment scenarios with thousands, or even millions, of devices while accommodating free will on the part of consumers and third parties. In one project (the GridWise® Olympic Peninsula Demonstration Project), transactive controls in distribution systems were used to reduce peak demand and manage wholesale prices by engaging consumer loads (e.g., HVAC systems and water heaters), commercial generation units, and large municipal water pumps.

### III. Using Transactive Control Frameworks for Ancillary Service Markets.

Ancillary service markets are widespread. An ancillary service market may pay reserve power capacity to be available to restore frequency levels and power interchanges with other systems to their nominal levels, following an imbalance. Ancillary service markets also include markets for secondary frequency control or regulation (i.e., generation and demand response capacity). In the United States, independent service operations (“ISOs”) and regional transmission operators (“RTOs”) such as CAISO, ERCOT, ISO-NE, MISO, PJM, and NYISO use different terminology for their ancillary service markets, including regulation, regulation reserve, and up-regulation/down-regulation service.

Some ISO/RTOs operate separate markets for up-regulation service and down-regulation service. One ISO/RTO defines down-regulation capacity as capacity to respond within five seconds between a generator's base point and the lowest sustainable limit, and similarly defines up-regulation capacity between a generator's base point and the highest sustainable limit. Other ISO/RTOs make no distinction between reserve capacities that are used to provide either up-regulation service or down-regulation service. Operating separate markets for up-regulation reserves and down-regulation reserves can help to better reflect system conditions. For example, down-regulation reserves may be valued more highly than up-regulation reserves at night time, when generation is high and load levels are low. In such situations, conventional units typically operate at their minimum generation level (or close to it), having greater up-regulation capacity than down-regulation capacity. A greater supply of up-regulation reserves implies that this up-regulation capacity should be priced lower than down-regulation capacity. Having separate markets for up-regulation service and down-regulation service allows differential prices to be made available to market participants. Different ISO/RTOs also differ in terms of minimum offer capacity (e.g., 1 MW, 0.1 MW), minimum ramp rate (e.g., 1 MW/minute), and maximum time to delivery (e.g., 5 minutes, 10 minutes, 10-30 minutes depending on service).

Different ancillary services have different characteristics. For example, ramping and spinning reserves are relatively slower acting, ranging from minutes to hours. Typically, spinning reserves and ramping target responsive energy consumption to be held to a certain level over a period of time on the order of several minutes. In contrast, a regulation service typically requires responsive energy consumption by a device to move up or down every few seconds in reaction to a system signal, the regulation signal, which is derived from the area control error that has a frequency component and a tie error component. Regulation requirements, as indicated in a regulation signal, are typically determined every few seconds, e.g., every 2 seconds or every 4 seconds.

The potential for transactive control approaches is far greater than demand response for peak load and wholesale price management. Ancillary service markets are one potential option for transactive control. Engaging responsive load resources (and potentially engaging distributed generation and storage) in bulk ancillary service markets may provide additional revenue for both consumers and an aggregator, increasing the value of distributed assets. Different types of devices may lend themselves better to different ancillary service markets, depending on the alignment of time scales, which provides opportunities for a wide variety of devices, for a range of different services. For example, demonstrations have shown that a retail market with a period of five minutes is appropriate for engaging most residential HVAC systems, due to alignment with the mechanical transition behavior of the HVAC systems and with most real-time energy markets. In addition, devices have significantly different availability during different times (e.g., day versus night, summer versus winter).

To simply extend a similar transactive system to a regulation market in a fine-grained way, the market period would change from minutes to seconds, involving two-way communication every 2-4 seconds, which is too fast for practical implementations. Device-level transactive bidding every 2-4 seconds may be impractical for some devices and communication systems. As a compromise, as described below, a market period (bid period) of roughly 5 minutes can be used for a device, which may then respond to a regulation signal every 2-4 seconds during a market period in which the device participates in the regulation market.

### IV. Example Transactive Control Framework for a Regulation Market.

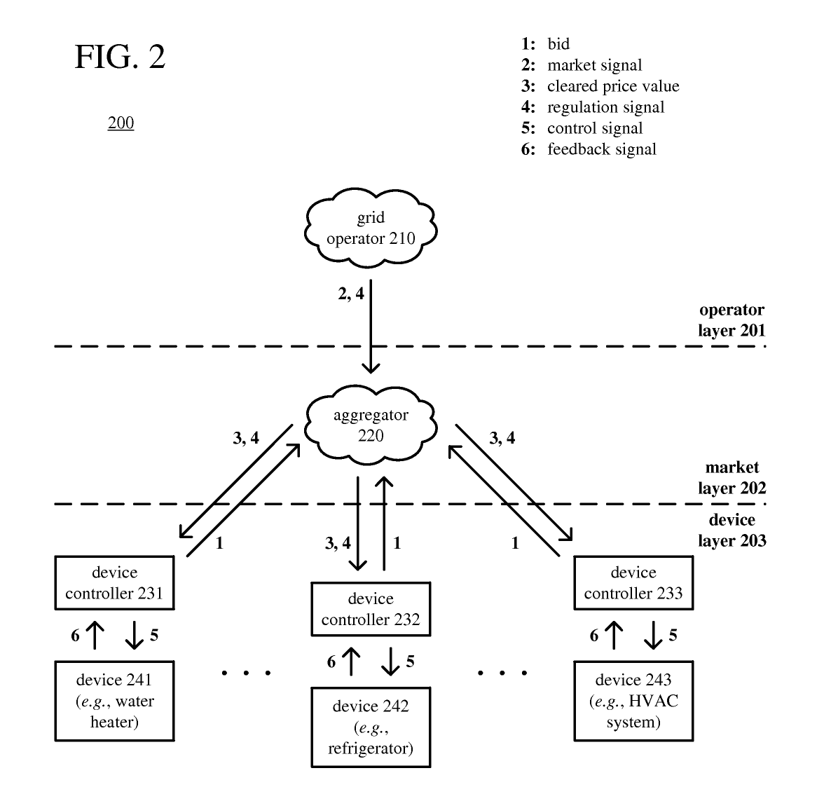

This section describes various aspects of a transactive control framework as applied to regulation services. FIG. 2 shows an example transactive control framework (200) for a power regulation market in which some described embodiments can be implemented. The example transactive control framework (200) has multiple layers, including an operator layer (201), a market layer (202) with an aggregator (220), and a device layer (203) with device controllers (231, 232, 233).

The operator layer (201) includes a grid operator (210), which can be an ISO or an RTO. For example, in the United States, the grid operator (210) is an ISO/RTO such as CAISO, ERCOT, ISO-NE, MISO, PJM, or NYISO. The grid operator (210) supplies information to the market layer (202), including a market signal used when determining a cleared price value and a regulation signal used by participants in the power regulation market.

The market layer (202) includes an aggregator (220), which acts as an intermediary between the grid operator (210) and device controllers (231, 232, 233) of the device layer (203). In general, the market layer (202) helps device controllers (231, 232, 233) transactively acquire resources during periods of the power regulation market. Typically, a market period has a timescale such as 5 minutes or 10 minutes.

The device layer (203) includes multiple device controllers (231, 232, 233) for controlling devices (241, 242, 243) in a distributed manner at much shorter timescales. The devices (241, 242, 243) can include different types of devices, such as water heaters, refrigerators, and HVAC systems. The devices (241, 242, 243) can also include individual, separately controllable components of water heaters, refrigerators, HVAC systems, or other consumer or commercial systems/units. Although FIG. 2 shows three device controllers (231, 232, 233) that control three devices (241, 242, 243), the device layer (203) can include hundreds, thousands, or more devices. The devices in the device layer (203) can be homogeneous devices (same type of devices; same behavior) or heterogeneous devices. During a market period in which one of the devices (241, 242, 243) participates in the regulation market, the corresponding device controller (231, 232, 233) controls the device in a distributed manner, so as to respond during one or more periods of power regulation. Typically, a regulation period has a timescale such as 2 seconds or 4 seconds, which is much shorter than the market period.

A. Activity at the Market Layer.

In some cases, the power regulation market is based on a formal double-auction market in which every x minutes (where x is 5, 10, or some other number of minutes) each of the devices (241, 242, 243) that may participate in the market has a bid provided through its device controller (231, 232, 233). In the bid, the device controller provides, e.g., an amount of resource the device is able to provide and a minimum price at which the device would be willing to provide the resource. The resource can be, e.g., power capacity that the device is willing to provide or power demand that the device is willing to forego. Examples of parameters in bids are provided below.

In the market layer (202), the aggregator (220) collects the bids from at least some of the device controllers (231, 232, 233), respectively. Using the collected bids and a market signal from the grid operator (210), the aggregator (220) determines a cleared price value to meet the target level of power regulation. Example approaches to determining the cleared price value are described below.

The aggregator (220) broadcasts the cleared price value to device controllers (231, 232, 233) for devices that may participate in the regulation market. Using the cleared price value, in a distributed manner, the device controllers (231, 232, 233) can decide whether or not their respective devices (241, 242, 243) will participate in the regulation market. If so, the device controller may form a contract to provide the resource in an amount consistent with its bid, at the price the market is willing to pay (the cleared price value). Collectively, this provides a mechanism for the aggregator to engage the least cost resources. By contract, the devices (241, 242, 243) that clear the market are now engaged for the market period as part of a distributed control system.

The aggregator (220) also broadcasts a regulation signal from the operator layer (201). The aggregator (220) can broadcast the regulation signal to the device controllers (231, 232, 233) for all devices or broadcast the regulation signal to the device controllers (231, 232, 233) for only those devices participating in the market during the regulation period.

B. Activity at the Device Layer.

Each of the device controllers (231, 232, 233) acts as an interface between the aggregator (220) and one or more devices (241, 242, 243). Although FIG. 2 shows a single device per device controller, a device controller (231, 232, 233) can manage multiple devices. Without loss of generality, most of the examples described herein involve a single device per device controller.

A device controller (231, 232, 233) uses local information to determine a bid per market period for its device. In the bid, the device controller can provide, e.g., an amount of resource the device is able to provide, a minimum price at which the device would be willing to provide the resource, and/or one or more other parameters. In general, the bid price is determined by the current state of the device (e.g., on or off) and the willingness of the device (or, indirectly, the consumer or third party) to participate (e.g., depending on the current temperature). Examples of bidding strategies and parameters in bids are provided below.

A device with a “winning” bid (that is, a device whose bid has a price value at or below the cleared price value) is engaged by the aggregator (220) during the market period. For a device engaged by the aggregator (220), the corresponding device controller uses a control algorithm to provide a regulation service for the resource that is available to be activated. The device controller (231, 232, 233) sends a control signal to its corresponding device (241, 242, 243) and may receive a feedback signal from the device.

Thus, any of the devices (241, 242, 243) that contract to participate in the market during the market period may respond to the regulation signal broadcast by the aggregator (220). The regulation signal can include signal values that change every 2 seconds, every 4 seconds, or at some other regulation period. In some examples, a participating device potentially changes states (e.g., on to off or off to on) according to a Markov-chain model, as described below. A device controller can use a stochastic decision-making process, as described below, when deciding whether its device will change states (e.g., on to off, off to on) in a given regulation period. Even when the response of any given device is stochastic (depends on a random variable), the aggregator (220) can rely on the aggregate behavior of a large number of devices to provide a smooth response to the regulation signal overall.

In some examples, a participating device potentially changes states in every regulation period. In other examples, a participating devices is limited in terms of the number of times the device can cycle between states (e.g., on to off, or off to on) when responding to the regulation signal during a market period. Limiting state changes can help avoid equipment damage for the device, which might otherwise be hurt by high-frequency switching. Example approaches to quantifying (as a QoS value) how many times a device is willing to switch between states within a market period are described below.

A device with a winning bid can be rewarded based on (1) its availability to be controlled and/or 2) its performance in delivering the resource as promised. That is, the device can be rewarded for making itself available in the regulation market, even it the device does not end up actively participating in the regulation market by changing states. The device can also be rewarded for actually delivering a resource as promised (e.g., providing power capacity in the amount specified in a bid, or decreasing power load by the amount specified in a bid). In some implementations, feedback signals from a device to its device controller can be conveyed to the aggregator (220) (and potentially to the grid operator (210) or another entity) to determine how a device is to be rewarded.

### V. Example Techniques for Transactive Control in an Ancillary Service Market.

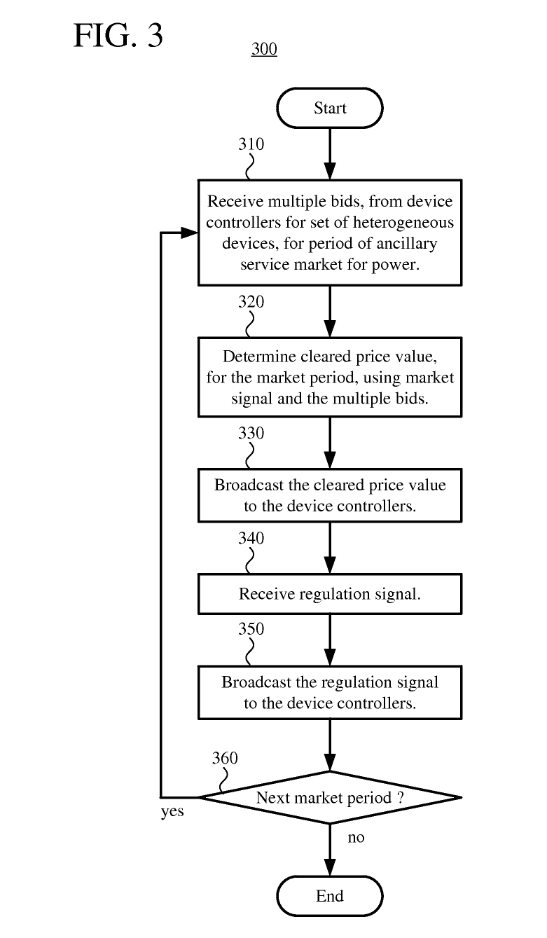

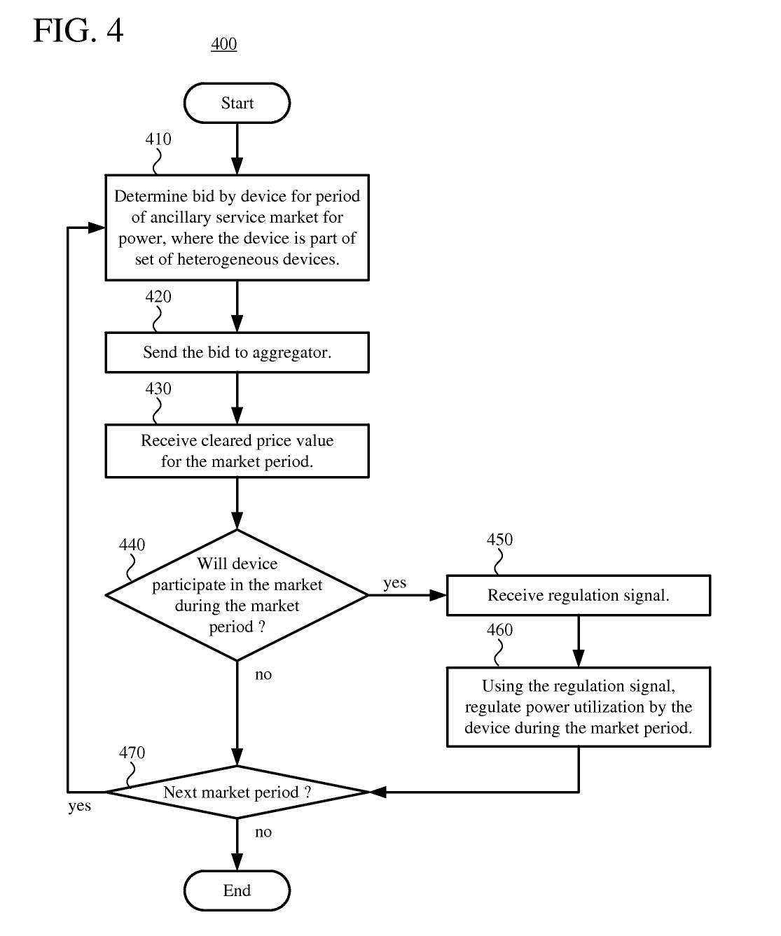

FIG. 3 illustrates a generalized technique (300) for participation in a transactive control framework for an ancillary service market with a set of heterogeneous devices, from the perspective of an aggregator. FIG. 4 illustrates a corresponding generalized technique (400) from the perspective of one of the device controllers for the set of heterogeneous devices. The ancillary service market can be an off-to-on power regulation market, an on-to-off power regulation market, a single power regulation that handles off-to-on transitions and on-to-off transitions, or some other type of regulation market.

The heterogeneous devices can include multiple types of consumer systems/units (such as refrigerators, air conditioners, water heaters, and clothes dryers) and/or commercial systems/units, as well as individual, separately controllable components of such consumer or commercial systems/units. The heterogeneous devices can include devices that operate according to different state transition models between discrete operating states for power utilization, as described below. Also, the heterogeneous devices can include devices that have different amounts of power available for participation during the period of the ancillary service market, as reflected in their bids, as described below. For example, different devices provide bids with different quantity values and/or different QoS values. Further, the heterogeneous devices can include devices whose device controllers apply different bidding strategies, as described below. Despite the differences among the devices, the devices can participate in the same ancillary service market.

With reference to FIG. 4, the device controller determines (410) a bid by its device for a period of an ancillary service market for power (“market period”). The market period can have a duration of 5 minutes, 10 minutes, or some other length of time. Examples of bidding strategies and parameters of bids are described below. For example, a given bid includes a quantity value (indicating an amount of power available, at the device, for participation during the market period), a price value (indicating a point at which the device is willing to make the amount of power available for participation during the market period), and a QoS value (indicating how many times the device is able to change between discrete operating states of the device during the market period). Alternatively, the device controller uses another bidding strategy and/or uses bids having different parameters. The device controller sends (420) the bid to an aggregator for the transactive control framework. Concurrently, one or more other device controllers also send bids by their respective devices to the aggregator (e.g., with parameters indicating quantity values, price values, and QoS values for the bids by the respective devices).

With reference to FIG. 3, the aggregator receives (310) multiple bids, from device controllers for the set of heterogeneous devices, for the market period. For example, the bids include parameters as described above.

The aggregator determines (320) a cleared price value (for the market period) that is based at least in part on a market signal and the multiple bids. For example, the aggregator sorts the multiple bids by price value. Then, the aggregator calculates, as a supply curve, cumulative sums for amount of power among the sorted bids. In doing so, quantity values for the sorted bids can be weighted by QoS values for the sorted bids, respectively. The aggregator also determines a demand curve based at least in part on the market signal, which can indicate a target price or target quantity. Then, the aggregator finds the cleared price value based at least in part on the supply curve and the demand curve. Examples of approaches for determining the cleared price value are described below. Alternatively, the aggregator uses another approach to determine the cleared price value. For example, the aggregator receives the cleared price value from an external module that sets the cleared price value. The aggregator broadcasts (330) the cleared price value for the market period to the device controllers for the set of heterogeneous devices.

With reference to FIG. 3, the aggregator also receives (340) a regulation signal. In general, the regulation signal is a series of signal values for periods of power regulation (e.g., 2 seconds, 4 seconds, or some other number of seconds). Typically, the periods of power regulation, respectively, are at least one order of magnitude shorter than the market period. The aggregator broadcasts (350) the regulation signal to the device controllers for the set of heterogeneous devices (that is, to all of the device controllers, or only to those device controllers whose devices have cleared the market and may participate during the market period).

With reference to FIG. 4, the device controller receives (430) the cleared price value for the market period. Then, the device controller decides (440) whether or not the device will participate in the ancillary service market during the market period. For example, the device controller compares the price value in the bid it sent (420) for the market period to the cleared price value. The device participates in the ancillary service market if the price value in the bid is less than or equal to the cleared price value. Otherwise, the device does not participate in the ancillary service market.

With reference to FIG. 4, when the device participates in the ancillary service market during the market period, the device controller receives (450) the regulation signal and, based at least in part on the regulation signal, regulates (460) power utilization by the device during the market period. In doing so, the device controller can use a stochastic decision-making process, as described below, or other decision-making process.

Otherwise (the device does not participate in the ancillary service market during the market period), the device controller can skip the receiving (450) and regulating (460) stages. The device controller can release control of the device back to its normal control function for the duration of the market period. In any case, the device controller checks (470) whether to continue in the next market period. If so, the device controller continues by determining (410) a bid by the device for the next market period.

Similarly, with reference to FIG. 3, the aggregator checks (360) whether to continue in the next market period. If so, the aggregator continues by receiving (310) multiple bids by devices for the next market period.

Although not shown in FIG. 4, a single device controller can determine bids for multiple devices, send bids for multiple devices, and control multiple devices.

### VI. Example Bidding Strategies for Transactive Control Framework.

This section describes example bidding strategies and example bid formats for information shared with the aggregator (220) as a central clearinghouse in a transactive control framework.

A. Example Bidding Strategies.

During a bidding cycle for a given period of an ancillary service market, a device controller (231, 232, 233) for a device (241, 242, 243) makes decisions about whether and how to participate in the ancillary service market.

Whether to Participate.

First, the device controller decides whether or not the device will participate in the ancillary service market. If there are multiple ancillary service markets, the device controller can also decide the market(s) in which the device will participate. For this decision, the device controller considers the current state of the device and whether the device has the ability to change states in the next market period. For example, if a refrigerator compressor has been running for 15 minutes in normal operation (such that its internal air temperature is within a safe range, and the refrigerator is not recovering from a defrost cycle or extended door opening), the refrigerator has the ability to turn off before the completion of its normal cycle. In fact, the refrigerator may already have a “desire” to change states from on to off as it approaches its lower deadband. On the other hand, a device may have recently changed states In this case, to protect equipment or ensure efficient operations, the device controller may decide that the device is not permitted to change states in the next market period. In some implementations, prior to the beginning of each market period, the device controller decides whether a device is permitted to participate in an on-to-off auction (by decreasing its current load), an off-to-on auction (by increasing its current load), or neither auction.

Price.

Next, if a device is permitted to participate in an ancillary service market, the device controller also determines how willing the device is to participate, as reflected in the price value in a bid by the device. The device operates as a supplier of a service (e.g., to increase or decrease power load, to increase or decrease power capacity). As such, the device controller offers a supply bid for the device. In general, a lower price will reflect a greater flexibility and greater willingness to participate in the market. In some implementations, the device controller determines prices uses a bidding strategy based on the methodology described in Hammerstrom et al., “Pacific Northwest Gridwise® Testbed Demonstration Project, Part I; Olympic Peninsula Project,” PNNL-17167 (2007) or Widergren et al., “AEP Ohio gridSMART® Demonstration Project: Real-Time Pricing Demonstration Analysis,” PNNL-23192 (February 2014).

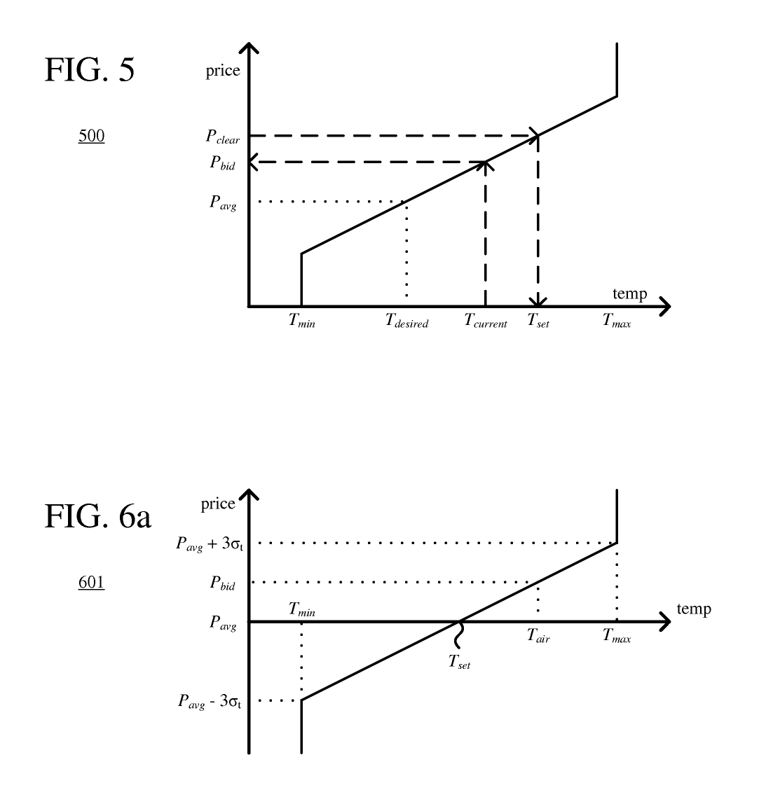

For example, FIG. 5 shows an example of a function that relates internal air temperature of a home to price. For a safe operating range, the temperature can fluctuate between a minimum temperature (Tₘᵢₙ) and a maximum temperature (Tₘₐₓ). In FIG. 5, the desired temperature set point (T_{desired}) is associated with an average price P_{avg}, which is, e.g., the average price over the last 24 hours. The temperature set point T_{desired} anchors the function to prices relative to the average price P_{avg}. The range of prices (relative to P_{avg}) can be calculated based on the cleared prices in the ancillary service market over the last 24 hours. According to the function, the device controller translates the current temperature (T_{current}) to a price value of a bid (P_{bid}). In general, a higher value for the current temperature (T_{current}) is associated with a higher desire to decrease temperature, and results in a higher price value. On the other hand, a lower value for the current temperature (T_{current}) is associated with a greater willingness to increase temperature, and results in a lower price value. The value σ_{avg} is the standard deviation of prices over the last 24 hours. For additional details, see PNNL-17167 and PNNL-23192.

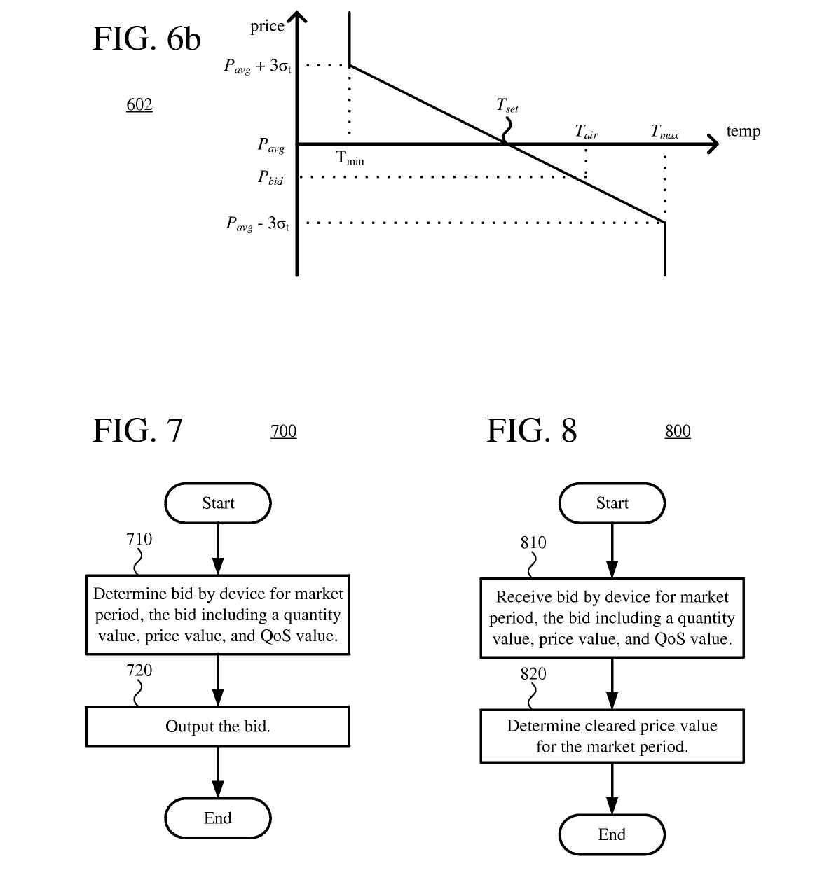

FIGS. 6a and 6b show other examples of functions that relate temperature to price, which can be used when determining the price value of a bid for several types of devices. In FIGS. 6a and 6b, the function of FIG. 5 is adapted to a refrigerator, HVAC system, or other thermostatically controlled load (“TCL”). If the device is on and operating within its safe operating range, specified by Tₘᵢₙ and the device may be willing to turn off. In this case, the bidding strategy is defined by the function shown in FIG. 6a. The temperature Tₘₐₓ at the high end of the operating range is associated with a high price (P_{avg}+3 σₜ), and the temperature Lₘᵢₙ at the low end of the operating range is associated with a low price (P_{avg}−3 σₜ). The function is anchored at a temperature set point (Tₛₑₜ) associated with the average price (P_{avg}). The measured current air temperature (Tₐᵢᵣ), in comparison to the temperature set point (Tₛₑₜ), indicates the willingness of the device to participate in the on-to-off market. For example, if T_{aff} is higher than Tₛₑₜ, the price value of the bid (P_{bid}) is higher than the average price (P_{avg}), indicating a lower willingness to switch to the off state. On the other hand, if Tₐᵢᵣ is lower than Tₛₑₜ, the price value of the bid (P_{bid}) is lower than the average price (P_{avg}), indicating a higher willingness to switch to the off state.

Similarly, if the device is off, the device may be willing to turn on. In this case, the bidding strategy is defined by the function shown in FIG. 6b. The temperature Tₘₐₓ at the high end of the operating range is associated with a low price (P_{avg}−3 σₜ), and the temperature Tₘᵢₙ at the low end of the operating range is associated with a high price (P_{avg}+3 σₜ). Again, the function is anchored at a temperature set point (Tₛₑₜ) associated with the average price (P_{avg}). The measured current air temperature (Tₐᵢᵣ), in comparison to the temperature set point (Tₛₑₜ), indicates the willingness of the device to participate in the off-to-on market. For example, if Lₐᵣ is higher than Tₛₑₜ, the price value of the bid (P_{bid}) is lower than the average price (P_{avg}), indicating a higher willingness to switch to the on state. On the other hand, if Tₐᵢᵣ is lower than Tₛₑₜ, the price value of the bid (P_{bid}) is higher than the average price (P_{avg}), indicating a lower willingness to switch to the on state.

The functions shown in FIGS. 5, 6a, and 6b are simple examples. In practice, the relationship between temperature and price can be more complex. For example, although FIGS. 5, 6a, and 6b show continuous, linear relations between temperature and price, the relation can alternatively be non-linear and/or non-continuous. Also, the end prices for the safe operating range of the device can be plus/minus three standard deviations from the average price, or they can be defined in some other way. In particular, a device manufacturer can define a function that relates temperature to price for a device such that short cycling is discouraged, or such that a device controller bids more strategically (e.g., using a predictive model). The functions shown in FIGS. 5, 6a, and 6b can be calibrated using average price values and standard deviation values calculated over rolling 24-hour windows. Or, the functions can be calibrated using average price values and standard deviation values calculated over a shorter period (e.g., 4 hours, 6 hours). The calibration period may be set depending on the period that a regulation signal remains generally un-biased, or depending on how much participation is required by the aggregator. The price can be specified in any unit of currency per unit of power (e.g., $/kW).

Aside from refrigerators and HVAC systems, the price value for other TCLs that have access to internal state measurements (temperature) can similarly be determined by a device controller. For example, a device controller can determine price values for bids for a heat pump water heater, which is typically able to measure effective water temperature. For devices that operate differently, a device controller can use a different method to calculate P_{bid}.

Amount.

The device controller also identifies a quantity of resource that the device uses. The quantity can be obtained from the manufacturer's specifications (e.g., the rated load in terms of kW of a compressor for a refrigerator or HVAC system). For example, a reasonable value for a refrigerator might be 0.15 kW. While there may be some variation between actual load and rated load for a device, the difference is usually negligible for purposes of transactive control.

For a regulation market, the quantity indicates the amount of resource the device can make available in a single state change. In some implementations, to indicate the market in which a device is participating at any given time (e.g., on-to-off, off-to-on), or to indicate the type of participation in a single market, the quantity is a signed value. If the device is able to reduce demand by the given amount, the quantity will be negative. If the device is able to increase demand by the given amount, the quantity will be positive.

QoS.

In practice, the overall amount of resource that a device can make available to participate in a regulation market depends on the quantity of resource that the device uses as well as how frequently the device can provide that quantity of resource. A quality of service (“QoS”) value indicates the number of times a device can perform a state change (for the quantity of the resource) during a market period. A device with a high QoS value can switch states more frequently than a device with a low QoS value. Hence, assuming other parameters (such as price value and quantity value) are equal, the device with the high QoS value is more valuable to the aggregator than the device with the low QoS value.

For example, the QoS value (QoS) for a device is defined as QoS=f×tₚ, where f is the maximum frequency at which the device can change states (state changes per second), and tₚ is the time between regulation signal updates (e.g., 2 seconds, 4 seconds). Suppose a refrigerator can only change states once per market period, so as to prevent fast-cycling. If the market period is 300 seconds (f=1/300) and the regulation period is 4 seconds (tₚ=4), the QoS value is 4/300=0.01333. QoS can be capped in its effective range. When f exceeds 1/tₚ, QoS is capped at 1. For example, if the device can change states every 3 seconds (f=⅓) but the time between regulation signal updates is 4 seconds (tₚ=4), QoS is capped at 1 (one change per regulation period). At the other extreme, when f is less than 1/tₘ (where tₘ is the market period in seconds), then QoS is tₚ/tₘ. For example, if the device can change states every 600 seconds (f=1/600), the market period is 300 seconds (tₘ=300), and the time between regulation signal updates is 4 seconds (tₚ=4), QoS is capped at 4/300=0.01333. In this situation, it is assumed that the device has already agreed to participate and therefore can be called upon.

The amount of resources available from an aggregated group of similar devices can be calculated by multiplying the amount for a single device by the number of devices. For example, suppose 10,000 identical refrigerators at 0.15 kW are aggregated at the market level. The aggregated refrigerators have an overall resource availability of 10,000×0.15×0.01333=20 kW. The amounts of resources available from diverse groups of devices can similarly be calculated by aggregation of the totals for the respective groups.

Although the functions used to compute price values of bids based on temperature may change from device to device, the device controller typically uses a single approach to identify quantity values and QoS values for any device that switches between discrete operating states. For a device that has continuous operating states, however, quantity and QoS values can be computed differently. For example, a variable speed fan has a continuous output from 0%-100% of demand. If the fan sits at 70% of its rated output, the fan could easily bid 30% of its total load with a QoS value of 1.0, but the efficiency of the fan is greatly affected by where it sits in the output curve. It may be more desirable to bid the first 15% at a lower value than the second 15%. Strategic bidding can play an important role in devices capturing the most value.

The QoS value for a device may also be used to determine the device's payment as a percentage of the overall resource that it provided.

A device controller can provide a new bid by its device in each new market period. For example, for each new market period in which its device may participate in the ancillary service market, the device controller provides a triplet (price value, quantity value, QoS value). In many cases, from bid to bid, the quantity value and QoS value are unchanged (since they depend on device attributes) but the price value changes depending on current state of the device. Alternatively, a device controller signals fewer parameters for a given bid, relying on the aggregator to reuse parameters (such as quantity value and/or QoS value) from the previous bid if parameters are missing from the given bid.

B. Generalized Approaches to Using Bids with QoS Values.

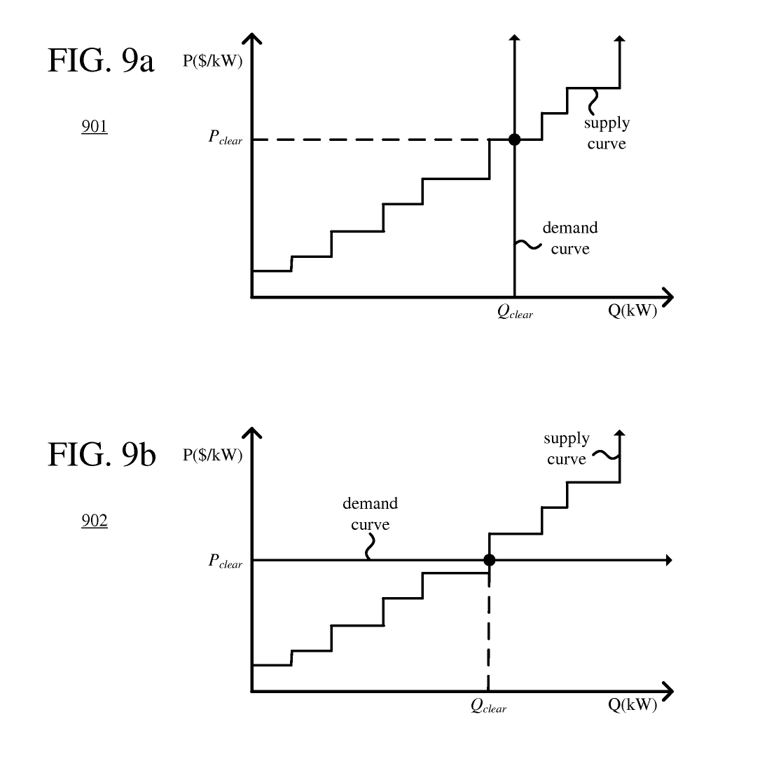

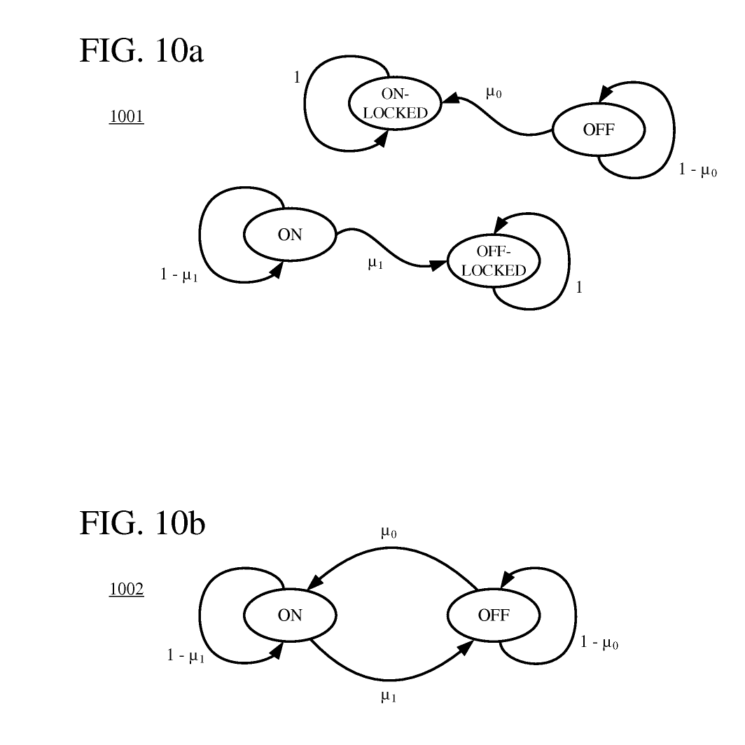

FIGS. 7 and 8 illustrate example techniques (700, 800) for using a bid that includes a QoS value, from the perspectives of a device controller (231, 232, 233) and aggregator (220), respectively. The example techniques (700, 800) can be used in a regulation market (e.g., on-to-off market, off-to-on market) for ancillary service or other type of energy market.

With reference to FIG. 7, a device controller in a transactive control framework determines (710) and outputs (720) a bid by its device for a period of an energy market (e.g., ancillary service market) for a resource. The bid has multiple parameters, including a quantity value, a price value, and a QoS value. The quantity value indicates an amount of the resource available, at the device, for participation during the period of the energy market. The price value indicates a point at which the device is willing to make the amount of the resource available for participation during the period of the energy market. The QoS value indicates how many times the device is able to change between discrete operating states of the device during the period of the energy market (and thereby change use of the amount of the resource). The device controller can set the QoS value, for example, depending on a time between signal values (in a regulation signal) for periods of power regulation and a frequency at which the device is able to change between the discrete operating states of the device. Alternatively, the device controller sets the QoS value in some other way.

With reference to FIG. 8, an aggregator for a transactive control framework receives (810) a bid by a device for a period of an energy market (e.g., ancillary service market) for a resource. The bid has multiple parameters, including a quantity value, a price value, and a QoS value defined as in the previous paragraph. Based at least in part on the bid and a market signal, the aggregator determines (820) a cleared price value for the period of the energy market. For example, when the bid is one of multiple bids for the period of the energy market, the aggregator sorts, by price value, the multiple bids. Then, the aggregator calculates, as a supply curve, cumulative sums for amount of the resource among the sorted bids. In this step, the quantity values for the sorted bids can be weighted by the respective QoS values for the sorted bids. The aggregator also determines a demand curve based at least in part on the market signal. Finally, the aggregator finds the cleared price value based at least in part on the supply curve and the demand curve. The next section includes additional details about example strategies for determining the cleared price value.

### VII. Example Strategies for Determining a Cleared Price Value.

This section describes behavior of the aggregator (220) as the central clearinghouse mechanism for the transactive control framework. Based on bids it receives from device controllers and based on a market signal, the aggregator determines a cleared price value for a given market for each market period. The market period can be 5 minutes, 10 minutes, or some other duration. The aggregator repeats the process for each new market period.

The aggregator receives bids from multiple device controllers before the close of a market for a market period. Bids received after the market closes are considered invalid—devices that provide late bids do not participate in the market, nor are such devices paid for participation. As such, the transactive control framework depends on communication mechanisms that can satisfy constraints on timely delivery of bids as well as market signals and regulation signals.

In some implementations, a regulation market is split into two coordinated, double-auction markets. An “up-regulation” market (also called an off-to-on market) is used to determine price and availability of resources to increase power consumption by devices that are currently off but able to turn on. A “down-regulation” market (also called an on-to-off market) is used to determine price and availability of resources to decrease power consumption by devices that are currently on but able to turn off.

The aggregator determines the number of devices available in each state (e.g., on versus off) at the beginning of the market period. Then, the aggregator calculates the market clearing price that will result in acquisition of the target amount of resource, as indicated by the market signal. In particular, when the market closes, the aggregator separates valid bids into an off-to-on regulation group and an on-to-off regulation group for the two independent markets, respectively. For each device that provides a bid, a quantity value (Q) can be multiplied by the QoS value (QoS) to get the effective amount of available resource (e.g., in kW) from the device.

For each of the markets, the aggregator can form a bid list of pairs of effective quantity, price values (Q×QoS, P). For each of the bid lists, the aggregator sorts the bid list from lowest price to highest price, and calculates the cumulative sum of effective amounts of the resource. The cumulative sums as price increases provide a supply curve for the market.

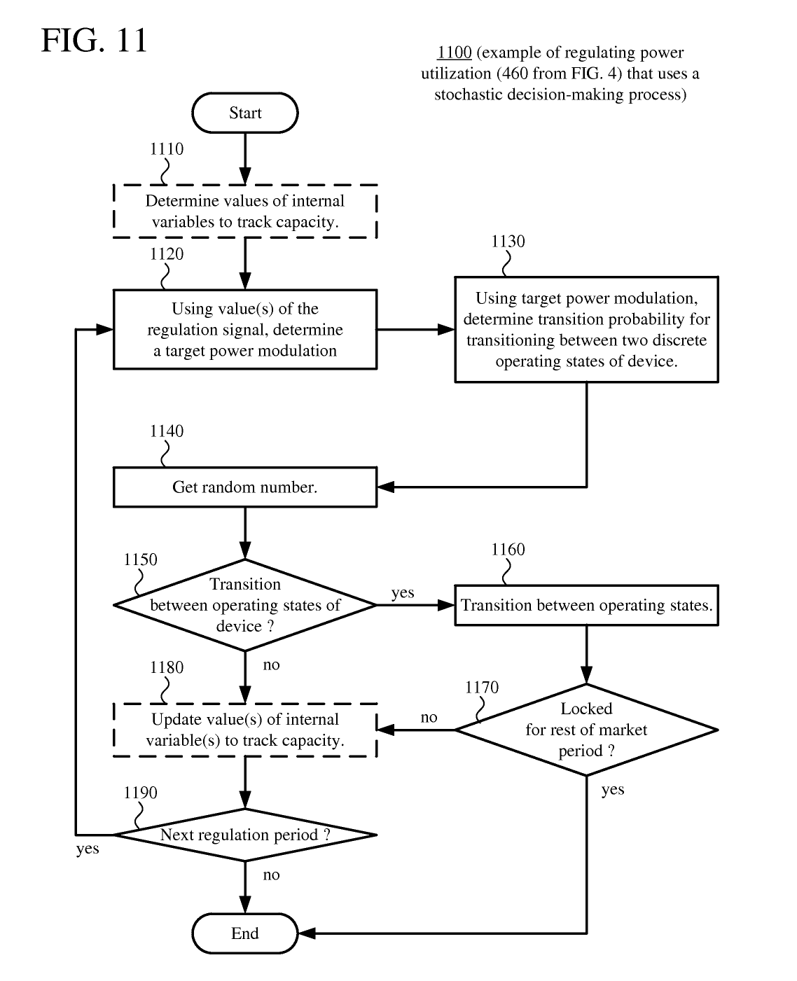

FIGS. 9a and 9b show example approaches (901, 902) to determining a cleared price value in a transactive control framework for one of the markets. As shown, the supply curve is a stepwise function. For a given increase in price, some effective amount of resource may become available to participate in the market, as indicated by one or more bids received by the aggregator.

The aggregator also calculates a demand curve. In FIGS. 9a and 9b, the demand curve is shown as a boundary condition. For a fixed quantity market (see FIG. 9a), the demand curve is specified as a fixed quantity received from the grid operator for the wholesale market, e.g., when the aggregator bids a quantity into the ancillary service market in order to procure the target amount of the resource. In this case, a bid clears the market when the cumulative sum of effective amount up to that bid in the sorted bid list is less than the demand curve. The aggregator can identify, as the cleared price value, the price value at the intersection of the supply curve and the demand curve. The aggregator can also identify the cleared quantity at the demand curve. The aggregator can calculate values for marginal clearing, exceeded capacity, and zero capacity markets as described in PNNL-17167 and PNNL-23192.

Alternatively, for a fixed price market (see FIG. 9b), the demand curve is specified as a fixed price received from the grid operator for the wholesale market, e.g., when distributed load is purely responsive to price fluctuations. In this case, a bid clears the market when the price of the bid is less than the demand curve. The aggregator can identify, as the cleared price value, the fixed price received from the grid operator. The aggregator can also identify the cleared quantity at the intersection of the supply curve and the demand curve. The aggregator can calculate values for marginal clearing, exceeded capacity, and zero capacity markets as described in PNNL-17167 and PNNL-23192.

In the preceding examples, the aggregator uses supply bids. In some implementations, the aggregator can also use demand bids to mitigate risk factors.

In this way, the aggregator calculates cleared price values and cleared quantity values for each of the markets (e.g., on-to-off market to decrease load, off-to-on market to increase load). The aggregator can use the curves for the on-to-off market and the off-to-on market to determine the maximum quantity the aggregator can supply to the regulation market, e.g., identifying the lowest maximum quantity between the two curves in order to determine the total available resource. (Some ISO/RTOs with up-regulation and down-regulation service require that resources for increasing loads and resources for decreasing loads be cleared in equal amounts, such that the aggregator can participate as an up-regulation resource or down-regulation resource, while being able to ramp in both up and down directions.)

Upon clearing of the market for a market period, the aggregator broadcasts the cleared price value for the market period to the device controllers for all of the participating devices. The aggregator can also broadcast the cleared quantity value for the market period. In some implementations, the device controllers can ignore the cleared quantity value—marginal sellers participate in the market. In other implementations, the aggregator broadcasts marginal fractions for use when large numbers of device have bids with the same price value, which can occur during periods of low diversity, in order to limit how many marginal sellers participate in the market.

The aggregator can receive bids from device controllers that control a set of heterogeneous devices. Bids for the heterogeneous devices can include a mixture of different QoS values and different quantity values. So long as the bids are discretized into price values, quantity values, and QoS values, the aggregator can incorporate the bids into the same transactive control framework, effectively allowing a single market to serve a large set of dissimilar devices.

### VIII. Example Strategies for Stochastic Control of Device.

This section describes example stochastic decision-making processes used by a control mechanism at one of the device controllers (231, 232, 233). Upon receiving the cleared price value for a market period, a device controller decides if its device (241, 242, 243) “won” or “lost” its bid. If the device won its bid (that is, the price value of the bid is less than or equal to the cleared price value), the device is engaged by the transactive control system and will participate in the market. On the other hand, if the device lost its bid (that is, the price value of the bid is greater than the cleared price value), the device is not engaged by the transactive control system and does not participate in the market, but rather continues to operate normally. Either way, the device has the option to participate in the market in later market periods, if the device so desires and is able to do so.

The devices that provide regulation services can be a set of heterogeneous devices, potentially including various numbers of refrigerators, water heaters, clothes dryers, and/or other discrete state devices, or individual controllable components of such systems/units, as well as fans and/or other continuous state devices with variable speed drives (“VSDs”), or individual controllable components of such systems/units. Among the set of heterogeneous devices, a device that wins its bid is added to the pool of devices that are engaged in the transactive control system to provide regulation services during the market period.

A. Example Regulation Signals.

When a device is engaged in the transactive control system, the device controller (231, 232, 233) for the device responds to a regulation signal from the aggregator (220), which conveys the regulation signal from the grid operator (210). A regulation signal includes signal values. For example, a regulation signal includes a signal value every n seconds, where n depends on implementation. If the ISO/RTO is PJM, n is 2. If the ISO/RTO is CAISO, n is 4. For other ISO/RTOs, n can have a different value. In some implementations, the signal values of the regulation signal are normalized to fall within the range {−1, 1}, and may be signaled with any of various levels of precision. The device controller receives the signal value of the regulation signal and may change the state of the controlled device in response.

In a large set of devices, each device controller can independently respond to the regulation signal. In this way, each controlled device may contribute a small, discrete amount of the resource. The aggregate effect for all controlled devices, however, is expected to follow the regulation signal. The device controllers need not receive other signals from the aggregator during the market period. Rather, the controlled devices are expected to respond stochastically, such that laws of probability as applied to a large number of devices result in acceptable control performance that tracks the regulation signal.

In some implementations, the regulation signal can be decomposed into a low-frequency component signal and high-frequency component signal, which are similar to PJM A and PJM D signals described in the article PJM Regulation Performance Senior Task Force, “Performance Based Regulation: Year One Analysis” (October 2013). PJM A is suitable for traditional resources with limited ramp rates and no limit on duration, while PJM D is suitable for fast-moving resources that can respond quickly but are unable to sustain that level of response for long periods. Separation into low and high-frequency component signals can help reward faster-acting regulation devices in a different manner than slower-acting regulation devices. In other implementations, the regulation signal is not decomposed into low and high-frequency component signals. In the examples that follow, the regulation signal can be a full signal (if no signal decomposition is used) or high-frequency component signal (if signal decomposition is used).

B. Example Stochastic Control Mechanisms.

Within a market period, resource utilization by a given device (241, 242, 243) can be controlled by a device-layer control mechanism that incorporates Markov chain logic. In response to the regulation signal, a device controller (231, 232, 233) for the device calculates one or more probability values for state transitions at a particular regulation period. Depending on the value of a random number, the current state of the device, and the probability value(s) calculated for the regulation period, the device controller decides whether the device will change states according to the control mechanism.

Because state changes can occur every few seconds if a device follows a regulation signal, a device controller may apply constraints that prevent too many state changes too close in time to each other. In some implementations, a device is limited in terms of the number of state changes allowed per market period. This constraint, which may be reflected in a QoS value for the device, can limit stress on the device.

In addition to responding to the regulation signal, a device may respond to other factors, such as the internal operating temperature of the device. A “natural” or “unforced” state change is a transition that would occur if the transactive control system were removed and the device returned to normal operation. A “forced” state change is a transition to a new state initiated by the device controller that would not have occurred through normal operations. In some implementations, when a device is engaged by the market-based control system, the device controller and device ignore natural state switching within each regulation period and consider only forced switching. Also, a forced state change can be held until the end of a market period, to limit the number state transitions.

1. State Models for Discrete State Devices—Generally.

This section describes modeling and controls for TCLs such as HVAC systems, water heaters, refrigerators and clothes dryers, or individual controllable components of such systems/units. Due to inherent thermal energy storage, these devices can often be switched from on-to-off or off-to-on for 30 seconds, a minute, or even several minutes without significantly affecting performance.

Such TCLs have a finite number of states, and they change their power consumption in discrete increments. The power consumption of the TCLs is assumed to be zero in the OFF state, and it is assumed to be a non-zero constant in the ON state. The total controllable power consumption at a bus is the sum of the power consumption of controllable TCLs in the ON state on the bus. A large number of TCLs can be controlled stochastically to closely follow an essentially continuous regulation signal. The objective for each device controller is to independently calculate the probability of its own device (TCL) turning ON or OFF. The device controller makes independent decisions to change the operating state of its device, such that the change in power consumption of the aggregation of the TCLs at a given bus matches the target power modulation according to the regulation signal received from the aggregator.

To address this problem, a device controller incorporates Markov chain logic into a model of the states of its device. A Markov chain representation implies that the transition probabilities at a given time depend only on the current state of the system and not the history of states.

Consider a population of N controllable loads (devices) with maximum capacity denoted by Pᵢ, i=1, 2, . . . N. Each controllable load has n operating states, with the corresponding capacity for the respective states denoted by Pᵢ^{j}, for j=1, 2, . . . n. For the same type of controllable load, Pᵢ^{j}=cⱼPᵢ with 0≦cⱼ≦1. Let C=[c₁ c₂ . . . cₙ]. The vector cⱼ that determines the relative ratios of power in the different states is the same for all controllable loads of the same type. For a set of two-state devices, this constraint is satisfied. If all devices in the population do not have the same n and cⱼ, however, then the population of devices is divided into subsets that satisfy the constraint on values in the vector Cⱼ. In the following examples, n and cⱼ are assumed to be the same for all devices of the population.

The value pⱼ(tₖ) denotes the expected fraction of controllable loads coming from those loads that are in the j^{th} operating state at time tₖε [symbol] . The vector p(tₖ) is defined as follows: p(tₖ)=[p₁(tₖ) p₂(tₖ) . . . pₙ(tₖ)]^{T}. At t=0, the expected fractions are the known fractions of loads in various states. Since the device controller considers forced switching between different operating modes during each market period, the evolution of the expected fractions pⱼ(tₖ) can be captured by the following Markov chain model.

$$p ( {t}_{k + 1} ) = A ( {t}_{k} ) p ( {t}_{k} ) \\ where \\ A ( {t}_{k} ) = [ \begin{matrix}1 - {\sum }_{j \neq 1}^{ } {μ}_{1 j} ( {t}_{k} ) & {μ}_{21} ( {t}_{k} ) & … & {μ}_{n 1} ( {t}_{k} ) \\ {μ}_{12} ( {t}_{k} ) & 1 - {\sum }_{j \neq 2}^{ } {μ}_{2 j} ( {t}_{k} ) & … & {μ}_{n 2} ( {t}_{k} ) \\ ⋮ & ⋮ & ⋱ & ⋮ \\ {μ}_{1 n} ( {t}_{k} ) & {μ}_{2 n} ( {t}_{k} ) & … & 1 - {\sum }_{j \neq n}^{ } {μ}_{nj} ( {t}_{k} )\end{matrix} ] , \qquad ( 1 ) ,$$

and where μᵢⱼ(tₖ) denotes the forced switching probability from the i^{th} operating state to the j^{th} operating state at tₖε [symbol] . The aggregate load power P(tₖ) is given by:

P(tₖ)=Cp(tₖ)Pₜₒₜ (2),

where Pₜₒₜ=Σᵢ₌₁^{N}Pᵢ. In the limit, when there is no load control (that is, μᵢⱼ(tₖ)=0 for tₖε [symbol] ) the aggregate load power P(tₖ) remains unchanging at the “nominal power” Pₜₒₜ.

The change in the expected value of the aggregate load power between times tₖ and tₖ₊₁ under load control can be represented as:

y(tₖ)=C[p(tₖ₊₁)−p(tₖ)]Pₜₒₜ (3).

If the transition probabilities are such that the above change is equal to the desired change based on the regulation signal, the requested level of service is provided to the grid.

If the desired power modulation of the aggregate load power is u(tₖ), the switching probabilities should satisfy the equation:

C[ₚ(tₖ₊₁)−p(tₖ)]Pₜₒₜ=u(tₖ) (4).

A controllable load in the i^{th} operating state switches to the j^{th} operating state at the probability of μᵢⱼ(tₖ). In general, equation (4) determines the transition probabilities μ, which are N(N−1) in number. Additional criteria can be imposed to affect characteristics for the transitions. For example, the sum of all μ's can be minimized at each regulation period as a way to minimize the number of transitions in the system of controllable loads at that regulation period. One extension of equation (4) addresses the case when the loads under control in the system are required to provide a fraction f of service, rather than the full service. Replacing u(tₖ) by f·u(tₖ) is equivalent to replacing Pₜₒₜ by by Pₜₒₜ/f. The aggregator simply broadcasts Pₜₒₜ/f as the controllable load. This extension is valuable in the case when the control signal u(tₖ) is broadcast to multiple sets of controllable loads, even though a particular set is expected to provide a portion of the service.

For additional details about Markov chain logic in state models for devices, see Kalsi et al, “Loads as a Resource: Frequency Responsive Demand,” PNNL SA-23764 (September 2014) and Moya et al., “A Hierarchical Framework for Demand-side Frequency Control,” American Control Conference (2014).

2. First Examples of State Models for Discrete State Devices.

This section describes state models for a special class of controllable loads (devices). With reasonable approximations, this class includes some refrigerators, some air conditioners/heat pumps, some water heaters, and some clothes dryers, or individual components (e.g., compressors) of such systems/units. For a variety of reasons (e.g., compressor cycle relaxation, decreased efficiency, equipment wear and tear), some devices cannot or should not transition quickly between states. For such devices, the state models used by a device controller can include one or more locked states. A locked state prevents additional state changes for a given amount of time (e.g., the rest of the market period, x seconds).

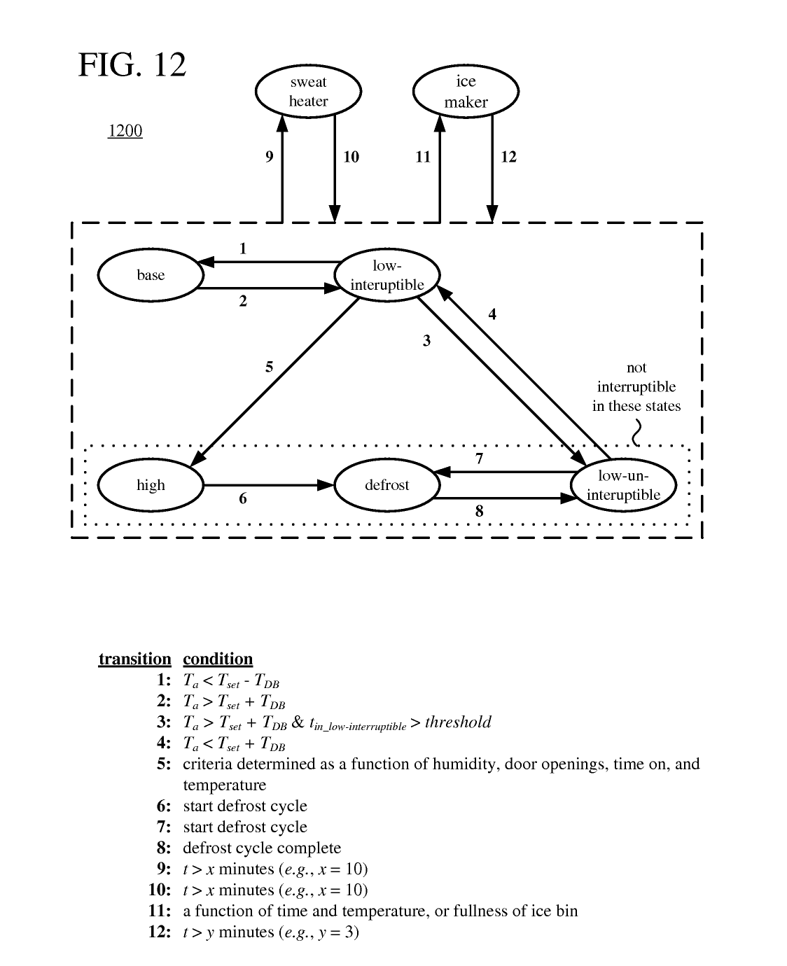

Suppose a device has four operating states: ON, OFF, ON-LOCKED, and OFF-LOCKED. If the device switches to one of the locked states (ON-LOCKED or OFF-LOCKED), then the device will stay in that locked state for a lockout duration (e.g., the rest of the market period, or x seconds, where x is 60, 120 or some other number). When controlling the device, the device controller ignores natural, unforced state switching within the market period, but considers “forced” switching due to the regulation signal. FIG. 10a illustrates forced transitions between operating states of such a device. In FIG. 10a, the value μ₁ indicates the (forced switching) probability of transitioning from the ON state to the OFF-LOCKED state. The value 1−μ₁ indicates the probability of remaining in the ON state. Similarly, the value μ₀ denotes the (forced switching) probability of transitioning from the OFF state to the ON-LOCKED state, and the value 1−μ₀ indicates the probability of remaining in the OFF state. For the state transition diagram shown in FIG. 10a, the transition matrix A(tₖ) is:

$$A ( {t}_{k} ) = [ \begin{matrix}1 - {μ}_{1} ( {t}_{k} ) & 0 & 0 & 0 \\ {μ}_{1} ( {t}_{k} ) & 1 & 0 & 0 \\ 0 & 0 & 1 - {μ}_{0} ( {t}_{k} ) & 0 \\ 0 & 0 & {μ}_{0} ( {t}_{k} ) & 1\end{matrix} ] . \qquad ( 5 )$$

The values p_{ON}(tₖ), P_{OFF}(tₖ), P_{ONLCK}(tₖ)) and P_{OFFLCK} (tₖ) indicate the expected fractions of the loads that are in ON, OFF, ON-LOCKED and OFF-LOCKED states, respectively, at time tₖ ε [symbol] . Since C is given by [1 0 0 1], with substitution according to equation (1), equation (4) can be reduced as follows:

$$C [ A ( {t}_{k} ) p ( {t}_{k} ) - p ( {t}_{k} ) ] {P}_{tot} = u ( {t}_{k} ) \\ [ \begin{matrix}1 & 0 & 0 & 1\end{matrix} ] [ [ \begin{matrix}1 - {μ}_{1} ( {t}_{k} ) & 0 & 0 & 0 \\ {μ}_{1} ( {t}_{k} ) & 1 & 0 & 0 \\ 0 & 0 & 1 - {μ}_{0} ( {t}_{k} ) & 0 \\ 0 & 0 & {μ}_{0} ( {t}_{k} ) & 1\end{matrix} ] [ \begin{matrix}{p}_{ON} ( {t}_{k} ) \\ {p}_{OFFLCK} ( {t}_{k} ) \\ {p}_{OFF} ( {t}_{k} ) \\ {p}_{ONLCK} ( {t}_{k} )\end{matrix} ] - [ \begin{matrix}{p}_{ON} ( {t}_{k} ) \\ {p}_{OFFLCK} ( {t}_{k} ) \\ {p}_{OFF} ( {t}_{k} ) \\ {p}_{ONLCK} ( {t}_{k} )\end{matrix} ] ] = \frac{u ( {t}_{k} )}{{P}_{tot}} \\ [ \begin{matrix}1 & 0 & 0 & 1\end{matrix} ] [ \begin{matrix}- {μ}_{1} ( {t}_{k} ) {p}_{ON} ( {t}_{k} ) \\ {μ}_{1} ( {t}_{k} ) {p}_{ON} ( {t}_{k} ) \\ - {μ}_{0} ( {t}_{k} ) {p}_{OFF} ( {t}_{k} ) \\ {μ}_{0} ( {t}_{k} ) {p}_{OFF} ( {t}_{k} )\end{matrix} ] = \frac{μ ( {t}_{k} )}{{P}_{tot}} \\ - {μ}_{1} ( {t}_{k} ) {p}_{ON} ( {t}_{k} ) + {μ}_{0} ( {t}_{k} ) {p}_{OFF} ( {t}_{k} ) = \frac{u ( {t}_{k} )}{{P}_{tot}} . \qquad ( 6 )$$

Equation (6) includes two transition probability values μ₀ and μ₁ at time tₖ. (In general, a transition matrix for a state model with 4 states has 4×(4−1)=12 transition probability values, not counting values along the diagonal, which are 1 or derived from other values in the column. For the state model shown in FIG. 10a, ten of the probability values are set to 0, as shown in equation (5), leaving two probability values.) For a given regulation period, the device controller calculates the forced switching probabilities μ₀(tₖ) and μ₁(tₖ) to match the required regulation service requested by the aggregator.

The device controllers can apply the criterion that the sum of transition probability values μ₀ and μ₁ should be minimized. For example, if a regulation period requires a given decrease in power, the device controllers might turn off a few extra devices and correspondingly turn on some devices. In this case, the minimization criterion ensures that no more than the minimum number of devices necessary is turned off, and that no device is turned on. This minimization criterion reduces to this: one of μ₀(tₖ) and μ₁(tₖ) should be zero. Since the transition probability values are constrained to be between 0 and 1, by further simplifying equation (6) to address different cases for u(tₖ):

$${μ}_{1} ( {t}_{k} ) = \frac{- u ( {t}_{k} )}{{P}_{tot} \cdot {p}_{ON} ( {t}_{k} )} , and {μ}_{0} ( {t}_{k} ) = 0 , if u ( {t}_{k} ) < 0 \\ {μ}_{1} ( {t}_{k} ) = 0 , and {μ}_{0} ( {t}_{k} ) = \frac{u ( {t}_{k} )}{{P}_{tot} \cdot {p}_{OFF} ( {t}_{k} )} , if u ( {t}_{k} ) > 0. \qquad ( 7 )$$

The values for the expected fractions p_{ON}(tₖ) and p_{OFF}(tₖ) are updated as follows:

P_{ON}(tₖ₊₁)=(1−μ₁(tₖ))P_{ON}(tₖ) (8).

P_{OFF}(tₖ₊₁)=(1−μ₀(tₖ))P_{OFF}(tₖ) (9).

The values of the expected frames p_{ONLCK}(tₖ₊₁) and P_{OFFLCK}(tₖ₊₁) can similarly be updated as follows:

P_{OFFLCK}(tₖ₊₁)=P_{OFFLCK}(tₖ)+μ₁(tₖ)p_{ON}(tₖ) (10).

P_{ONLCK}(tₖ₊₁)=P_{ONLCK}(tₖ)+μ₀(tₖ)P_{OFF}(tₖ) (11).

In some implementations, equations (7)-(11) are the same for every device.

At t=0, p_{ON}(0) and p_{OFF}(0) are given. When u(0) is received, a device controller calculates μ₁(0) and μ₀(0) as in equation (7). The device controller generates (or otherwise gets) a random number and transitions accordingly, as described below. The device controller also calculates p_{ON} (1) and p_{OFF}(1), and is ready to repeat this process for t=1. The device controller repeats this process for different regulation periods, until the conclusion of the market period.

With respect to equation (7), if P_{OFF}(0) is 0, and u(0)>0, equation (7) has no solutions satisfying the constraint that the transition probability values be between 0 and 1. Physically, this means that if no devices are off, and an increase in power consumption is needed, the increase in power consumption cannot be accomplished. This results in a control error. (In this case, the transition probability values are set to 0 or 1, as appropriate, and the device controller moves to the next regulation period.) Also, if the resources are inadequate for the service required in a market period, p_{ON} and/or p_{OFF} may be so small that equation (7) results in one or both of the transition probability values exceeding 1, again resulting in a control error.

3. Second Examples of State Models for Discrete State Devices.

This section describes state models for another class of controllable loads (devices), which lacks lock states. With reasonable approximations, this class includes some refrigerators, some air-conditioners/heat pumps, some water heaters, some clothes dryers, and some storage-based devices such as electric vehicles, or individual controllable components of such systems/units.

Suppose a device has two operating states: ON and OFF. When controlling the device, the device controller ignores natural, unforced state switching within the market period, but considers “forced” switching due to the regulation signal. FIG. 10b illustrates forced transitions between operating states of such a device. In FIG. 10b, the value μ₁ indicates the (forced switching) probability of transitioning from the ON state to the OFF state. The value 1−μ₁ indicates the probability of remaining in the ON state. Similarly, the value μ₀ denotes the (forced switching) probability of transitioning from the OFF state to the ON state, and the value 1−μ₀ indicates the probability of remaining in the OFF state. For the state transition diagram shown in FIG. 10b, the transition matrix A (tₖ) is a simplified 2×2 matrix. The device controller calculates and updates transition probability values μ₀ and μ₁ and expected fraction values p_{ON} (tₖ) and p_{OFF}(4) between regulation periods, according to equations (7)-(9).

4. Example Stochastic Control Mechanisms.

This section describes example stochastic control mechanisms that can be used with the preceding example state models.

At the beginning of a market period (bid period), through its device controller, each device (controllable load) provides a bid indicating its operating state, power, and a price to the aggregator. The aggregator collects all the information, determines the winning bids, and broadcasts the cleared price value. The aggregator also broadcasts the total capacity of all cleared bids (Pₜₒₜ), the fraction of the total capacity in the ON state (p_{ON} (0)), and the fraction of the total capacity in the OFF state (p_{OFF}(0)). The values of p_{ON} (0) and p_{OFF}(0) are defined as:

P_{ON}(0)=(Σ_{devices in on state}Capacity of device)/(Σ_{All devices}Capacity of device)), and

P_{OFF}(0)=(Σ_{devices in off state}Capacity of device)/(Σ_{All devices}Capacity of device)).

The aggregator also broadcasts R(−1), which is, for example, 0.

From the cleared price value for the market, the device controller can determine whether or not its device won its bid. If so, the device controller stores the values Pₜₒₜ, p_{ON}(0) and p_{OFF}(0) and continues by processing signal values of the regulation signal R. The signal value broadcast at time tₖ is R(tₖ).

In particular, for a device with a winning bid, the device controller responds to the change in signal values, which indicates the desired power modulation: u(tₖ) [symbol] R(tₖ)−R(tₖ₋₁). At time t=0, when R(0) is received, the device controller computes u(0) [symbol] R(0)−R(−1). From u(0), the device controller computes ρ₁(0) and μ₀(0) according to equation (7). The device controller generates a random number between 0 and 1.

For a device having a state model as shown in FIG. 10a, if the device is in the ON state and the random number is less than μ₁(0), then the device transitions to OFF-LOCKED state. On the other hand, if the device is in the OFF state and the random number is less than μ₀(0), then the device transitions to ON-LOCKED state. For a device having a state model as shown in FIG. 10b, if the device is in the ON state and the random number is less than μ₁(0), then the device transitions to OFF state. On the other hand, if the device is in the OFF state and the random number is less than μ₀(0), then the device transitions to ON state. The device controller also updates the values of the expected fractions p_{ON} (1) and p_{OFF} (1) according to equations (8) and (9), respectively.

At time t=1, when R(1) is received, the device controller computes u(1) [symbol] R(1)−R(0). From u(1), the device controller computes μ₁(1) and μ₀(1) according to equation (7). The device controller generates a random number between 0 and 1.

For a device having a state model as shown in FIG. 10a, if the device is in the ON state and the random number is less than μ₁(1), then the device transitions to OFF-LOCKED state. On the other hand, if the device is in the OFF state and the random number is less than μ₀(1), then the device transitions to ON-LOCKED state. For a device having a state model as shown in FIG. 10b, if the device is in the ON state and the random number is less than μ₁(1), then the device transitions to OFF state. On the other hand, if the device is in the OFF state and the random number is less than μ₀(1), then the device transitions to ON state. The device controller also updates the values of the expected fractions p_{ON}(2) and p_{OFF}(2) according to equations (8) and (9), respectively.

The device controller continues for subsequent regulation periods, responding to signal values for t=2, 3, 4, . . . .

For a device having a state model as shown in FIG. 10a, as soon as the device reaches the ON-LOCKED state or OFF-LOCKED state for the rest of a market period, its device controller can stop calculating values for the stochastic control mechanism, since the device can no longer transition between states during the market period. If the lockout duration is less than the remainder of the market period, upon expiration of the lockout duration, the device can switch from ON-LOCKED state to ON state, or it can switch from OFF-LOCKED state to OFF state.

5. Example Techniques for Stochastic Decision-Making Processes.

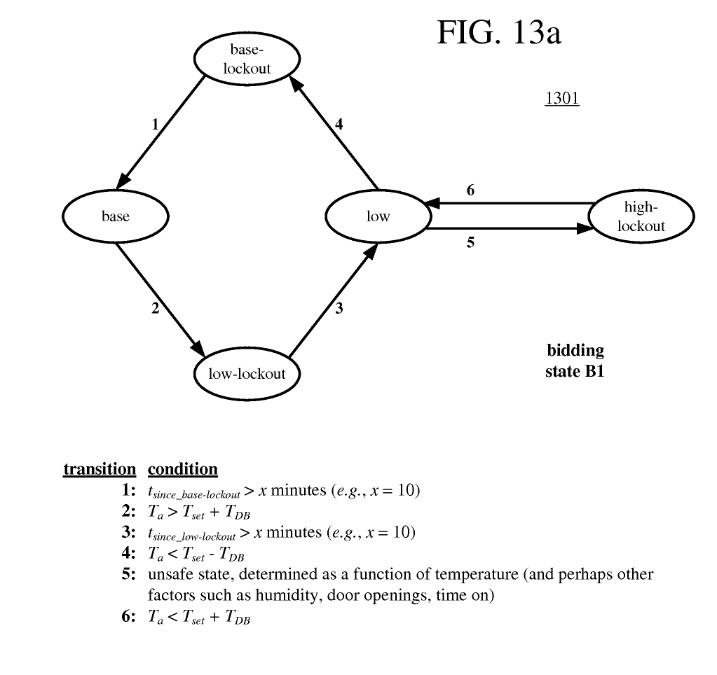

FIG. 11 shows an example technique (1100) for regulating utilization of a resource using a stochastic decision-making process. A device controller (231, 232, 233) as described with reference to FIG. 2, or other device controller for a device in a transactive control framework, can perform the technique (1100). The device controller receives a regulation signal and, based at least in part on the regulation signal, regulates utilization of a resource (e.g., power capacity, power load) by the device during a period of an energy market (e.g., ancillary service market). When it regulates utilization of the resource, the device controller uses a stochastic decision-making process.

As part of the stochastic decision-making process, the device controller (1110) can determine values of internal variables to track capacity. For example, the device controller gets, from an aggregator, values of a total capacity for cleared bids (Pₜₒₜ), a fraction of the total capacity in an on state (p_{ON} (0)), and a fraction of the total capacity in an off state (p_{OFF}(0)), as described in the preceding sections. Alternatively, the device controller determines values of other and/or additional internal variables to track capacity.

For a given regulation period, the device controller determines (1120) a target power modulation based at least in part on the regulation signal. For example, the device controller uses the current signal value R(tₖ) of the regulation signal and the previous signal value R(tₖ₋₁) of the regulation signal to calculate a target power modulation: u(tₖ) [symbol] R(tₖ)−R(tₖ₋₁). Alternatively, the device controller determines the target power modulation in some other way.

Then, based at least in part on the target power modulation, the device controller determines (1130) a transition probability value for transitioning between two discrete operating states of the device. For example, the device controller determines transition probability values μ₁(tₖ) and μ₀(tₖ) based on the target power modulation u(tₖ) according to equation (7). In calculating the transition probability value, the device controller can also use internal variables that track capacity (e.g., use Pₜₒₜ and one of p_{ON}(tₖ) and p_{OFF}(tₖ)). Alternatively, the device controller determines transition probability value(s) in some other way.

The device controller gets (1140) a random number. For example, the device controller generates the random number or receives the random number from an external random number generator.

Then, based at least in part on the random number and the transition probability value(s), the device controller decides (1150) whether to transition between the two discrete operating states of the device. In making the decision (1150), the device controller can also consider the current state of the device (e.g., whether the device is in ON state or OFF state). (When the device is in a locked state (e.g., a locked state that does not last for the entire market period), the device controller decides not to transition between states.)

If the device controller decides to transition between two states, the device controller causes the device to transition (1160) between the two states. For example, the device transitions from an ON state to an OFF state or OFF-LOCKED state, as described above. Or, the device transition from an OFF state to an ON state or ON-LOCKED state, as described above. After the transition, the device controller checks (1170) whether the device is now in a locked state for the remainder of the market period. If so, the device controller ends the stochastic decision-making process.

If the device has not transitioned to a locked state that lasts the remainder of the market period, based at least in part on the transition probability value(s), the device controller can update (1180) the value(s) of one or more internal variables to track capacity. For example, the device controller updates the value of one of p_{ON}(0) and p_{OFF}(0), as described in the preceding sections. Alternatively, the device controller updates values of other and/or additional internal variables to track capacity.

Finally, the device controller checks (1190) whether to continue in a next regulation period of the market period. If so, the device controller continues by determining (1120) a target power modulation, for the next regulation period, based at least in part on the regulation signal. In the additional iteration, the device controller also repeats the determining (1130) the transition probability value, the getting (1140) the random number, the deciding (1150) whether to transition between operating states, and so on.

6. Variations for State Models for Continuous State Devices

This section describes variations of state models for fans and other continuous state devices with variable speed drives (“VSDs”), as well as transactive control mechanisms for VSDs that participate in an ancillary service market. A device with a VSD can increase or decrease its power continuously within its operating range. A device with a VSD can, by itself, follow the regulation signal R as long as a fraction of the regulation signal R is assigned to the device with the VSD that is consistent with its range.

For example, suppose the i^{th} device with a VSD has a current power reading of Pᵢ. In addition to a price value, in a bid by the device, a device controller for the device provides a quantity value Pᵢ^{H}, such that Pᵢ+P_{H} represents the highest possible power during the market period for the device with the VSD. The device controller also provides, in the bid, a quantity value Pᵢ^{L}, such that Pᵢ+Pᵢ^{L} represents the lowest possible power during the market period for the device with the VSD. The aggregator collects all bids and broadcasts Pₜₒₜ^{H} and Pₜₒₜ^{L}. The device controller for the device with the VSD, when it receives the regulation signal value R(tₖ), moves to a new power state given by:

$${P}_{i} + \frac{{P}_{i}^{H}}{{P}_{tot}^{H}} ( R ( {t}_{k} ) - R ( - 1 ) ) if R ( {t}_{k} ) > R ( - 1 ) , or$$

$${P}_{i} + \frac{{P}_{i}^{L}}{{P}_{tot}^{L}} ( R ( {t}_{k} ) - R ( - 1 ) ) if R ( {t}_{k} ) < R ( - 1 ) .$$

The aggregator can choose to assign a fraction of the total regulation needed to the set of VSDs.

7. Example Transitions and State Models for Refrigerators.

This section describes examples of transitions and state models for sophisticated refrigerators that include multiple modes of operation. The examples incorporate Markov chain logic that approximates real-world devices.

The largest contributor for power and energy demand of a refrigerator is the compressor, which cycles on and off to maintain internal air temperature near a pre-set value. In some models, the compressor may be dual-speed—low for normal operations, or high to pre-cool the refrigerator before a defrost cycle or recover from an unsafe temperature. Aside from additional compressor load (from pre-cooling), the defrost cycle activates heaters around the cooling coils to melt accumulated ice on the coils. There are a number of other processes in a typical refrigerator, depending upon model, make, and age of the refrigerator. These other processes may include anti-sweat heaters (sometimes called “sweat heaters”) for eliminating moisture from the outer shell, fans for moving air from one compartment to another, ice makers, lights, and power electronics. The power demand for such processes can vary significantly depending on size of the unit, manufacturer, efficiency rating, etc. The following table shows rough approximations of the power demand of typical processes within a refrigerator and average times they might be in a given state.

| | Demand | Avg. Time |
|---|---|---|
| State | (W) | On (minutes) |
| base | ~25 | ~45 |
| compressor (low) interruptible (+base) | ~100 | ~60 |
| compressor (low) uninterruptible (+base) | ~100 | ~120 |
| compressor (high) (+base) | ~150 | ~60 to ~75 |
| defrost (+base) | ~400 | ~20 to ~30 |
| sweat heaters (+base) | ~10 | ~10 |
| ice maker (+base) | ~100 | ~3 |

Also, to some degree, consumer interaction with the refrigerator affects behavior. In particular, the duty cycle of the compressor and the frequency of the defrost cycle increase as a consumer opens the door more often and/or places more hot food into the cavity. Overall, however, the daily load shape for a refrigerator tends to be roughly uniform across the time of day. This may be useful, as it means that the amount of resource available from the refrigerator is somewhat independent of the time of day.

In a refrigerator, some cycles are not interruptible (or should not be interrupted). For example, interrupting the compressor shortly after it has started, if such interruption happens consistently without taking into consideration the current runtime of the compressor, may cause damage or excessive wear and tear. As another example, once a defrost cycle has started, it should not be interrupted. As another example, if the temperature of the refrigerator cavity climbs to an unsafe level, the compressor cycle should not be interrupted. For these reasons, the device controller does not use the refrigerator for ancillary service by turning the entire unit off or on. Instead, the device controller controls certain individual processes (components) within the refrigerator.

Guidelines have been published regarding energy reduction methods in refrigerators, including guidelines for making refrigerators demand-response compliant. For example, according to some guidelines, ice making is deferrable for at least four hours, and longer deferral is acceptable, provided the ice-making process has not already started. As another example, according to some guidelines, a pre-cooling and defrost cycle can be deferred for four hours, provided the cycle has not already begun. As another example, according to some guidelines, for shorter time periods (10-15 minutes), the refrigerator is able to reduce demand by 50% from baseline operations.

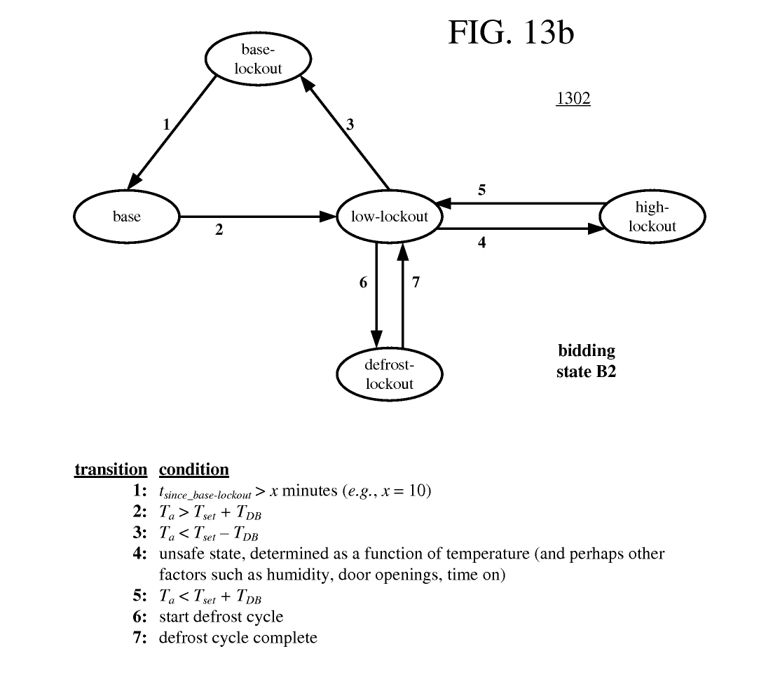

FIG. 12 shows an example state model (1200) for a “smart” refrigerator having multiple processes, including state transitions between some of the states. The value Tₐ represents the air temperature for the refrigerator (or freezer). For the most part, state transitions are driven by the air temperature for the freezer, but the term refrigerator is used herein to indicate either the refrigerator or the freezer. The value Tₛₑₜ represents the temperature set point for the refrigerator. The value TDB represents a constant offset around the temperature set point Tₛₑₜ, which helps the refrigerator avoid quick changes between cycles. The compressor of the refrigerator is active in the low-interruptible, low-uninterruptible, and high states.

As shown in FIG. 12, the refrigerator transitions from the low-interruptible state to the base state if Tₐ<Tₛₑₜ−TDB. The refrigerator stays in the base state so long as this condition is satisfied, but switches to the low-interruptible state if Tₐ>Tₛₑₜ+T_{DB}.

The refrigerator switches from the low-interruptible state to the low-uninterruptible state if Tₐ>Tₛₑₜ+T_{DB} and the refrigerator has been in the low-interruptible state for a threshold amount of time (tᵢₙ_{_{—}}_{low-interruptible}>threshold). The threshold depends on implementation, e.g., 5 minutes, 10 minutes, or 20 minutes. From the low-uninterruptible state, the refrigerator switches back to the low-interruptible state if Tₐ<Tₛₑₜ+T_{DB}.

From the low-interruptible state, if certain criteria are satisfied, the refrigerator can also transition to the high state, which is associated with pre-cooling before a defrost cycle. For example, this decision to transition to the high state can be a function of humidity, a count of door openings, time spent running, and current temperature. From the high state, the refrigerator transitions to the defrost state when it starts a defrost cycle. Typically, the transition to the defrost state depends on the refrigerator reaching a particular low temperature point. The refrigerator can also transition to the defrost state from the low-uninterruptible state (e.g., when the particular low temperature point is reached, and other criteria for starting the defrost cycle are satisfied). From the defrost state, the refrigerator transitions to the low-uninterruptible state when the defrost cycle has completed, which typically takes a defined amount of time. When in the high state, defrost state, or low-uninterruptible state, the refrigerator is not interruptible.

The sweat heater and ice maker operate independent of the compressor. The sweat heater can be activated anytime it has been inactive for more than x minutes, then remains active for x minutes. The value of x depends on implementation, e.g., x is 10 minutes. The sweat heater is interruptible. The ice maker can be activated for various reasons, e.g., depending on temperature, time since last activation, or fullness of an ice bin. Activation of the ice maker can be delayed.

The state model shown in FIG. 12 can be reduced to a group of simpler state models that are associated with bidding states. The simpler states align the Markov chain logic with bidding strategies consistent with certain subsets of controllable behaviors of the refrigerator. A bidding state indicates what processes of the refrigerator are current available for modification, and hence defines what control actions are available to the device controller. The following table shows example bidding states.

| Bidding State | | Load Available for |
|---|---|---|
| Number | Bidding State | Shifting (Up or Down) |
| B1 | normal | compressor |
| | thermostatic | |
| B2 | defrost desired | defrost cycle/high compressor |
| | | (available for up-regulation service) |
| B3 | sweat heater | sweat heater |
| B4 | ice maker | ice maker |

In some implementations, the bidding states B1 and B2 are mutually exclusive. If the refrigerator seeks to start a defrost cycle, then the device controller does not make the compressor available for up-regulation service or down-regulation service. The device controller can switch to bidding state B1, however, and defer the defrost cycle. Bidding states B3 and B4 are independent from other states. Bidding state B3 or B4 can occur regardless of what is happening with other bidding states.

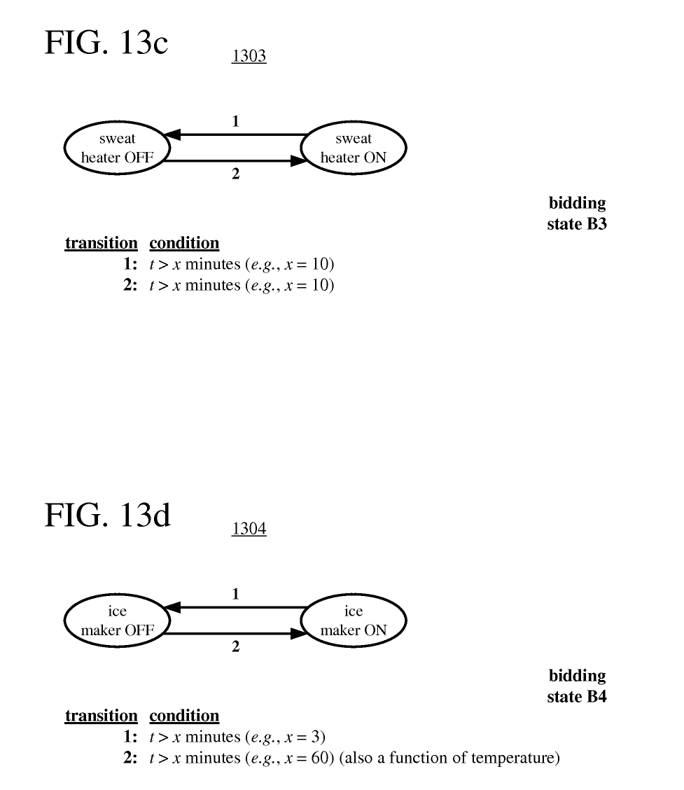

In bidding state B1, the device controller can bid availability to turn on the compressor (transition from base state to low-lockout state) or bid availability to turn off the compressor (transition from low state to base-lockout state). Once the refrigerator enters the base-lockout state or low-lockout state, the device controller is unable to change states for a pre-defined amount of time, thereby protecting against over-cycling of the compressor. The pre-defined amount of time for the lockout duration can be determined by the device manufacturer, and may be a different value for different devices. In FIG. 13a, the pre-defined value is 10 minutes. The pre-defined lockout duration can be longer than the market period (which is, e.g., 5 minutes), in which case the device controller opts out of one or more later market periods. After the expiration of the lockout duration, the refrigerator switches from the base-lockout state to the base state, or switches from the low-lockout state to the low state.

If the refrigerator does not participate in the market, the refrigerator may still change states as shown in FIG. 13a. The refrigerator transitions from the low state to the base-lockout state if Tₐ<Tₛₑₜ−T_{DB}. The refrigerator transitions from the base state to the low-lockout state if Tₐ>Tₛₑₜ+T_{DB}.

The high-lockout state is included as a safety precaution, which the device controller does not override. If the refrigerator cavity reaches an unsafe temperature requiring high cooling capacity, then the refrigerator will enter the high-lockout state and cannot participate in load shifting. The refrigerator can transition from the high-lockout state back to the low state when Tₐ<Tₛₑₜ+T_{DB}.

As shown in FIG. 13b, bidding state B2 is similar to bidding state B1 in many respects. In bidding state B2, the device controller can bid availability to turn off the compressor (transition from low state, or low-lockout state, to base-lockout state) or bid availability to activate the defrost cycle (transition from low state, or low-lockout state, to defrost-lockout state). Over an extended period, the defrost cycle has a higher power demand than just the compressor. Entering the defrost cycle enters a locked state with a series of controlled events (high cooling, defrosting of coils, and high cooling) that will not be interrupted once started. The start of the series of events, however, can be delayed for a number of hours.

As shown in FIG. 13c, in bidding state B3, the device controller can bid availability to turn on the sweat heater (transition from sweat heater OFF state to sweat heater ON state) or bid availability to turn off the sweat heater (transition from sweat heater ON state to sweat heater OFF state), within certain constraints on runtime. Device manufacturers may define the constraints in terms of minimum runtime and maximum runtime. In FIG. 13c, an approximate duty cycle of 50% with average runtime of 10 minutes is shown.

As shown in FIG. 13d, in bidding state B4, the device controller can bid availability to turn on the ice maker (transition from ice maker OFF state to ice maker ON state). There is considerable flexibility in turning on the ice maker. Once the ice-making cycle is started, however, it takes a few minutes and the ice maker is not available for load reduction.

### IX. Example Approaches to Configuring Device Controllers.

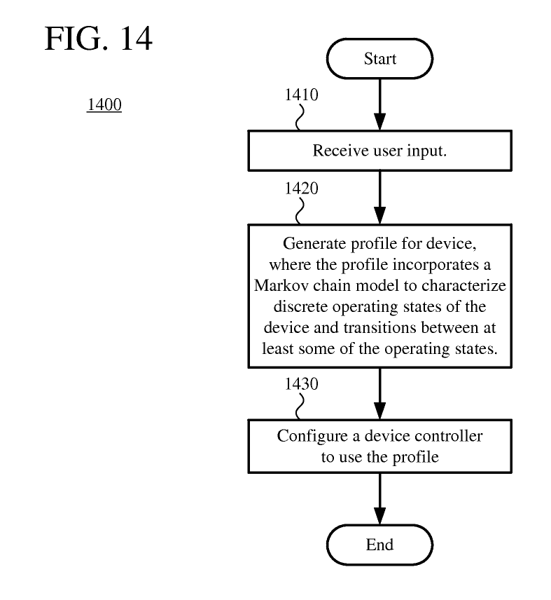

FIG. 14 illustrates an example technique (1400) for configuring a device controller in a transactive control framework. A configuration tool for the transactive control framework performs the technique (1400). The configuration tool can be managed by a device manufacturer, device installer, or other entity.

The configuration tool receives (1410) user input. For example, the configuration tool receives user input from an engineer of a device manufacturer, who is familiar with characteristics of the device (e.g., states, transitions, quantity of power used, lockout durations).

Based at least in part on the user input, the configuration tool generates (1420) a profile for a device in an energy market for a resource. The profile incorporates a Markov chain model to characterize discrete operating states of the device and characterize transitions between at least some of the discrete operating states of the device. For example, the discrete operating states of the device include an ON state, an OFF state, an ON-LOCK state, and an OFF-LOCK state. As described above, the Markov chain model can use transition probability values to represent transitions between the respective states of the device. The profile can also include information about quantity of a resource that the device can make available and QoS that the device can provide in a regulation market, for use by a device controller when determining bids by the device.

The configuration tool configures (1430) a device controller to use the profile. For example, the configuration tool stores the profile in storage accessible to the device controller. The device controller can load the profile when controlling the device in the transactive control framework. The configuration (1430) of the device controller can happen long after the profile is generated (1420), using a different component of the configuration tool. For example, at that later stage, the component of the configuration tool loads the profile from a network storage area or other storage area, then configures (1430) the device controller to use the profile.

### X. Other Considerations and Implementation Choices.

This section describes various considerations and implementation choices in a transactive control framework.

Forced switching versus unforced switching.

In many of the preceding examples, the transactive control system assumes that when a device is in a given state, it remains in that state unless instructed to change by its device controller. In many cases, the natural rate of state change for a device (that is, the rate of unforced switching, based on normal operation of the device) is much slower than the rate of forced switching, so that even without enforcement of this assumption, the amount of error introduced is negligible. For example, in a device with a large amount of thermal mass, such as a water heater, the natural rate of state chance is likely to be much slower than the rate of forced switching according to a transactive control mechanism.

In other cases, however, systems may have a rapid natural rate of state change (relative to the market period). For example, an HVAC system may be oversized (to provide rapid cooling) or may be used during an extremely hot period (experiencing rapid warming). If allowed to operate using its normal control function (in addition to regulation through a device controller for a transactive control framework), the device might either (1) change states prior to a controller-initiated state change or (2) return back to its prior state after a controller-initiated state change. This can lead to inconsistencies between the modeled states within the device controller and the actual distribution of states. This is especially true when considering that the market will tend to choose devices that are most likely to change states during the market period anyway, as their desire to change states will be reflected by a lower bid price.

To address this problem, the device controller can disable unforced switching when a transactive control mechanism is used. Or, the device controller can check the current state of a device during stochastic decision-making processes and, if the state has switched, accept that state switch as a result and update values accordingly. The device controller can periodically check that a device remains in the state expected during a market period, especially when the device is supposed to be in a locked state.

Alternatively, a device controller allows its controlled device to switch between states according to the normal control function of the device, even after the device controller has forced a state change using the transactive control mechanism. In this case, a device can respond to control signals from its device controller and respond to control signals from its normal control function (e.g., due to sudden temperature fluctuations). When natural, unforced switching is permitted, the actual state of any given device becomes less deterministic, potentially causing deviation (error) between the expected states of controlled devices and actual states of controlled devices.

Delays in Communication.

Communication technology can influence the behavior of a transaction-based control system, having a direct impact on consumers and the control of the system. Some control systems described herein use not only two-way 5-minute market information but also one-way 4-second (or 2-second) broadcasts of a regulation signal. High communication delays in providing bids to an aggregator can lead to devices participating in a market that should not participate. High communication delays in providing a cleared price value for the market can lead to incorrect or late decisions by device controllers. Or, high communication delays can affect the behavior of the market clearing, eventually leading to an “unsolvable” market that erroneously settles to a price cap. Various approaches can be used to satisfy communication needs for demand response and regulation. Communication standards such as ANSI/CEA 2045 that can accommodate multiple technologies such as Wi-Fi, cellular and radio frequency are evolving. Devices conforming to such standards may even be installable by homeowners.

Co-simulation of the behavior of a power system, loads, control system, market, and communication network may allow users to explore a wide range of possible communication impacts (such as latency, lost information, congestion on shared network resources, and security) on the reliability of the control system. The simulation environment can also be used to determine the minimum requirements of the communication network, including whether it is sufficient to layer multiple control systems on the same network, or whether a stand-alone communication network is required. Also, rather than minimize the amount of communication used for a control system, refactoring may create a control system more robust to communication failures.

In some implementations, a device controller is required to send a bid by its device at least 30 seconds prior to the close of bidding for a market period, to increase the chance that the bid is timely received prior to market closing.

Number of Devices Controlled.

The transactive control approaches described herein work best with a large population of controlled devices having a diversity of states. In this situation, for any given target power modulation, there will be enough devices able (and willing) to provide an adequate response through the duration of a market period. Also, having a large population of controlled devices can help provide a higher precision response, since a significant jump by any given device will have proportionally smaller contribution to the overall load change. The minimum count for a population of controlled devices and minimum count for devices participating in a market during a market period depend on implementation and goals of the transactive control system. In some scenarios, having at least 500 devices overall and at least 25 devices participating in a market during a market period has been sufficient.

Measurement and Verification.

The transactive control system can measure the performance of controlled devices in order to verify that the controlled devices are providing the appropriate level of a resource or service. In the case of regulation services, the response of the controlled devices should sufficiently track the regulation signal. The transactive control system can use the results of measurement and verification to reward participating devices and/or penalize devices that have not satisfied their contractual obligations after engaging in the transactive control system.

For measurement and verification at the device level, the transactive control system can use data already available to the aggregator (e.g., status information provided in bids), advanced metering systems, and/or utility supervisory control and data acquisition (“SCADA”) systems. For example, the transactive control system can use interval meter data analysis with non-intrusive load monitoring. Or, the transactive control system can infer state changes within a market period based on reported state information (from bids) from the starts and ends of market periods, and infer whether a controlled device behaves as instructed over a longer period. The measurement and verification should be accurate and detailed enough to serve the purposes of the transactive control system, without imposing a significant additional communication cost.

The transactive control system can also measure the performance of an aggregator in order to verify that the aggregator controls enough devices throughout a market period to track the regulation signal. For a given market period, the aggregator should control enough devices to be able react to changes in the regulation signal at the end of the market period, even if devices are locked after making one state change. If the supply of controllable devices is exhausted, the aggregator will be unable to deliver the requested service in response to a regulation signal. The term “mileage” indicates the total change in power generation or load, both up and down, within a given market period. Generally, the “mileage” that controlled devices provide should be sufficient to track the total amount of movement in a regulation signal. The transactive control system can use data already available to the aggregator (e.g., status information provided in bids) to track the overall performance of a group of devices and verify that the service requested by an aggregator throughout a market period can actually be delivered by the group of devices.

Choice of cleared quantity. Participating devices are expected to provide a share of regulation requested by the transactive control system. A given set of devices can be assigned a share of the total regulation that is requested. The aggregator can set the share of total regulation that the given set of devices are to provide, considering the increase in power load by devices transitioning from an OFF state to an ON state for up-regulation service and considering the decrease in power load by devices transitioning from an ON state to an OFF state for down-regulation service.

For example, suppose r_{α,i} represents the signal value of a regulation period i for a regulation signal in market period α. The value P_{α}⁺ indicates the power consumed by the devices that clear the up-regulation market if the devices start in the OFF state, and the value P_{α}⁻ indicates the power that would be consumed by the devices that clear the down-regulation market if the devices start in the ON state. In some implementations, P_{α}⁺ and P_{α}⁻ are required to be equal, with the common power regulation indicated by P_{α}.

The aggregator assigns some share f of the total regulation to a given set of devices. The desired power consumption profile is given by P_{α}(1+f·r_{α,i}). The aggregator ensures that power consumption profiles, summed over all sets of devices participating in regulation, equals the amount of regulation the aggregator is expected to provide to the grid.

The aggregator determines an appropriate value off for a given set of devices, such that the requested up-regulation service mileage can be provided by the devices that clear the up-regulation market, and the requested down-regulation service mileage can be provided by the devices that clear the down-regulation market. When the change in regulation signal values (that is, r_{α,i+i}−r_{α,i}) is positive, certain number of devices in the ON state should change state to OFF state. Similarly, when the change in regulation signal values (r_{α,i+i}−r_{α,i}) is negative, certain number of devices in the OFF state should change state to ON state.

The aggregator determines a value of f for a set of devices such that the devices can likely provide the requested regulation service and such that regulation capacity of the devices is effectively used. If the value of f is too high (devices are asked to provide too much regulation service), in many cases, there will not be enough devices to provide the requested regulation services. As f decreases, so does the share of regulation provided by the set of devices, and consequently utilization of the devices, but there should be fewer instances of devices being unable to provide requested regulation service in a market period. If the value of f is too low, however, regulation capacity of the devices may be wasted, even if instances of the devices being unable to provide requested regulation service in a market period are avoided. The aggregator can set the value of f for a set of devices to balance the risk of regulation service failures against the risk of underutilizing regulation capacity.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. In a computer system that implements an aggregator for a transactive control framework, the computer system comprising a processor and memory, a method comprising:
receiving multiple bids, from device controllers for a set of heterogeneous devices, for a period of an ancillary service market for power;
determining a cleared price value, for the period of the ancillary service market, that is based at least in part on a market signal and the multiple bids;
broadcasting the cleared price value for the period of the ancillary service market to the device controllers for the set of heterogeneous devices;
receiving a regulation signal; and
broadcasting the regulation signal to the device controllers for the set of heterogeneous devices.

2. The method of claim 1, wherein the set of heterogeneous devices includes:
at least two devices that operate according to different state transition models between discrete operating states for power utilization;
at least two devices that have different amounts of power available for participation during the period of the ancillary service market; and/or
at least two devices whose device controllers apply different bidding strategies.

3. The method of claim 1, wherein, for a given bid of the multiple bids, multiple parameters of the given bid include:
a quantity value indicating an amount of power available, at a given device among the set of heterogeneous devices, for participation during the period of the ancillary service market;
a price value indicating a point at which the given device is willing to make the amount of power available for participation during the period of the ancillary service market; and
a quality of service value indicating how many times the given device is able to change between discrete operating states of the given device during the period of the ancillary service market.

4. The method of claim 3, wherein the set of heterogeneous devices includes at least two devices that provide bids with different quantity values and/or different quality of service values.

5. The method of claim 1, wherein the determining the cleared price value includes:
sorting, by price value, the multiple bids;
calculating, as a supply curve, cumulative sums for amount of power among the sorted bids;
determining a demand curve based at least in part on the market signal; and
finding the cleared price value based at least in part on the supply curve and the demand curve.

6. The method of claim 5, wherein quantity values for the sorted bids are weighted by quality of service values for the sorted bids, respectively.

7. The method of claim 1, wherein the determining the cleared price value includes receiving the cleared price value from an external module that sets the cleared price value.

8. The method of claim 1, wherein the regulation signal is a series of signal values for periods of power regulation, and wherein the periods of power regulation, respectively, are at least one order of magnitude shorter than the period of the ancillary service market.

9. The method of claim 1, wherein the ancillary service market is an off-to-on power regulation market or an on-to-off power regulation market.

10. The method of claim 1, wherein the heterogeneous devices include multiple types of consumer systems/units or components of such consumer systems/units, the multiple types of consumer systems/units being selected from the group consisting of refrigerators, air conditioners, water heaters, and clothes dryers.

11. A computer system comprising a processor and memory, wherein the computer system implements a device controller for a device in a transactive control framework, the device controller being configured to:
determine a bid by the device for a period of an ancillary service market for power, wherein the device is part of a set of heterogeneous devices under the transactive control framework;
send the bid to an aggregator for the transactive control framework;
receive a cleared price value for the period of the ancillary service market;
decide whether or not the device will participate in the ancillary service market during the period of the ancillary service market; and
when the device participates in the ancillary service market during the period of the ancillary service market:
receive a regulation signal; and
based at least in part on the regulation signal, regulate power utilization by the device during the period of the ancillary service market.

12. The computer system of claim 11, wherein the regulation of power utilization by the device uses a stochastic decision-making process.

13. The computer system of claim 12, wherein the stochastic decision-making process includes:
based at least in part on the regulation signal, determining a target power modulation;
based at least in part on the target power modulation, determining a transition probability value for transitioning between two discrete operating states of the device; and
based at least in part on a random number and the transition probability value, deciding whether to transition between the two discrete operating states of the device.

14. The computer system of claim 13, wherein the stochastic decision-making process further includes:
determining a total capacity for cleared bids, a fraction of the total capacity in an on state, and a fraction of the total capacity in an off state, wherein the transition probability value is also based at least in part on the total capacity and one of the fraction of the total capacity in the on state and the fraction of the total capacity in the off state; and
based at least in part on the transition probability value, updating the one of the fraction of the total capacity in the on state and the fraction of the total capacity in the off state.

15. The computer system of claim 14, wherein the stochastic decision-making process further includes, in each of one or more additional iterations, repeating the determining a target power modulation, the determining a transition probability value, the deciding whether to transition, and the updating.

16. The computer system of claim 13, wherein the two discrete operating states are:
an off state and an on-lock state; or
an on state and an off-lock state.

17. The computer system of claim 11, wherein multiple parameters of the bid include:
a quantity value indicating an amount of power available, at the device, for participation during the period of the ancillary service market;
a price value indicating a point at which the device is willing to make the amount of power available for participation during the period of the ancillary service market; and
a quality of service value indicating how many times the device is able to change between discrete operating states of the device during the period of the ancillary service market.

18. The computer system of claim 11, wherein the regulation signal is a series of signal values for periods of power regulation, and wherein the periods of power regulation, respectively, are at least one order of magnitude shorter than the period of the ancillary service market.

19. The computer system of claim 11, wherein the ancillary service market is an off-to-on power regulation market or an on-to-off power regulation market.

20. The computer system of claim 11, wherein the heterogeneous devices include multiple types of consumer systems/units or components of such consumer systems/units, the multiple types of consumer systems/units being selected from the group consisting of refrigerators, air conditioners, water heaters, and clothes dryers.

21. One or more computer-readable media storing computer-executable instructions for causing a processor, when programmed thereby, to perform operations of a device controller for a device in a transactive control framework, the operations comprising:
receiving a regulation signal; and
based at least in part on the regulation signal, regulating utilization of a resource by the device during a period of an energy market, wherein the regulating uses a stochastic decision-making process that includes:
based at least in part on the regulation signal, determining a target power modulation;
based at least in part on the target power modulation, determining a transition probability value for transitioning between two discrete operating states of the device; and
based at least in part on a random number and the transition probability value, deciding whether to transition between the two discrete operating states of the device.

22. The one or more computer-readable media of claim 21, wherein the stochastic decision-making process further includes:
determining a total capacity for cleared bids, a fraction of the total capacity in an on state, and a fraction of the total capacity in an off state, wherein the transition probability value is also based at least in part on the total capacity and one of the fraction of the total capacity in the on state and the fraction of the total capacity in the off state; and
based at least in part on the transition probability value, updating the one of the fraction of the total capacity in the on state and the fraction of the total capacity in the off state.

23. The one or more computer-readable media of claim 22, wherein the stochastic decision-making process further includes, in each of one or more additional iterations, repeating the determining a target power modulation, the determining a transition probability value, the deciding whether to transition, and the updating.

24. The one or more computer-readable media of claim 21, wherein the two discrete operating states are:
an off state and an on-lock state; or
an on state and an off-lock state.

25. The one or more computer-readable media of claim 21, wherein the energy market is an ancillary service market, and wherein the resource is power capacity or power load.

26. In a computer system that implements a configuration tool for a transactive control framework, the computer system comprising a processor and memory, a method comprising:
receiving user input;
based at least in part on the user input, generating a profile for a device in an energy market for a resource, wherein the profile incorporates a Markov chain model to characterize discrete operating states of the device and characterize transitions between at least some of the discrete operating states of the device; and
configuring a device controller to use the profile.

27. The method of claim 26, wherein the discrete operating states of the device include an on state, an off state, an on-lock state, and an off-lock state.

28. A computer system comprising a processor and memory, wherein the computer system implements a device controller for a device in a transactive control framework, the device controller being configured to:
determine a bid by the device for a period of an energy market for a resource, the bid having multiple parameters that include:
a quantity value indicating an amount of the resource available, at the device, for participation during the period of the energy market;
a price value indicating a point at which the device is willing to make the amount of the resource available for participation during the period of the energy market; and
a quality of service value indicating how many times the device is able to change between discrete operating states of the device during the period of the energy market; and
output the bid.

29. The computer system of claim 28, wherein the device controller is further configured to set the quality of service value of the bid depending on:
a time between signal values, in a regulation signal, for periods of power regulation; and
a frequency at which the device is able to change between the discrete operating states of the device.

30. The computer system of claim 28, wherein the energy market is an ancillary service market.

31. A computer system comprising a processor and memory, wherein the computer system implements an aggregator for a transactive control framework, the aggregator being configured to:
receive a bid by a device for a period of an energy market for a resource, the bid having multiple parameters that include:
a quantity value indicating an amount of the resource available, at the device, for participation during the period of the energy market;
a price value indicating a point at which the device is willing to make the amount of the resource available for participation during the period of the energy market; and
a quality of service value indicating how many times the device is able to change between discrete operating states of the device during the period of the energy market; and
based at least in part on the bid and a market signal, determining a cleared price value for the period of the energy market.

32. The computer system of claim 31, wherein the bid is one of multiple bids for the period of the energy market, and wherein the determining the cleared price value includes:
sorting, by price value, the multiple bids;
calculating, as a supply curve, cumulative sums for amount of the resource among the sorted bids;
determining a demand curve based at least in part on the market signal; and
finding the cleared price value based at least in part on the supply curve and the demand curve.

33. The computer system of claim 32, wherein quantity values for the sorted bids are weighted by quality of service values for the sorted bids, respectively.

34. The computer system of claim 31, wherein the energy market is an ancillary service market.

35. One or more computer-readable media storing computer-executable instructions for causing a processor, when programmed thereby, to perform operations of an aggregator for a transactive control framework, the operations comprising:
receiving a market signal;
based at least in part on the market signal and multiple bids from device controllers for devices, determining a cleared price value for a period of an ancillary service market for a resource;
broadcasting the cleared price value for the period of the ancillary service market to the device controllers;
receiving a regulation signal; and
broadcasting the regulation signal to the device controllers for regulation, according to a stochastic decision-making process, of utilization of the resource by the devices during the period of the ancillary service market.
